(19) United States
(12) Patent Application Publication
(10) Pub. No.: US 2022/0219958 A1
(43) Pub. Date: Jul. 14, 2022

(54) AUTOMATIC ADAPTER SPOTTING FOR AUTOMOTIVE LIFT

(71) Applicant: Vehicle Service Group, LLC, Madison, IN (US)

(72) Inventors: Steven Taylor, Hanover, IN (US); Austin Deuerling, Madison, IN (US); Robert Elliott, Madison, IN (US); Roger Ward, Madison, IN (US)

(73) Assignee: Vehicle Service Group, LLC, Madison, IN (US)

(21) Appl. No.: 17/573,894

(22) Filed: Jan. 12, 2022

Related U.S. Application Data
(60) Provisional application No. 63/136,260, filed on Jan. 12, 2021.

(51) Int. Cl. B66F 7/28; B66F 17/00

(52) U.S. Cl. CPC B66F 7/28; B66F 17/00

(57) ABSTRACT

A vehicle lift system uses locally and globally available datasets to provide various automated and semi-automated lift positioning modes that may be used to position lift arms and engage adapters with lift points of a vehicle. A set of sensors are used to determine a position and orientation of a vehicle within a lift area. Each lift arm includes a camera that is coupled to the lift arm with a static field of view relative to the adapter despite extension, retraction, or rotation of lift arm members. The cameras provide images of the adapter and its surroundings that may be analyzed with object recognition to identify the vehicle's lift points. Lift point positions may also be determined using back-calculation. Automatic positioning of the lift arms may be performed based on identified lift points and may also include projection of an optical locator from a locator within the adapter.

### PRIORITY

This application claims priority of U.S. Provisional Patent Application No. 63/136,260, entitled “Automatic Adapter Spotting for Automotive Lift,” filed Jan. 12, 2021.

### FIELD

The disclosed technology pertains to automatically positioning a vehicle lift.

### BACKGROUND

Lifting vehicles during service can be a time-consuming, labor-intensive, and dangerous process. Vehicle lifts have varying designs and capabilities, including drive-on or in-ground lifts that lift a parked vehicle by raising the parking surface in order to allow access to the underside of the vehicle, as well as frame engaging lifts that raise a vehicle by contacting structural lifting points on the underside frame of the vehicle, which allow access to the underside of the vehicle as well as allowing wheels and tires to be removed or serviced.

Since vehicle service often includes removing or inspecting tires and wheels, frame-engaging lifts are a popular option. Two-post lifts are a popular type of frame-engaging lift and generally have a post positioned on each side of a vehicle area, as well as a lifting member that can be vertically raised and lowered along each lift post. To allow for compatibility with a variety of vehicles, lifting members will typically have a number of adjustable features that allow the lifting members to reach and engage with vehicle lift points in a variety of locations on a vehicle within the vehicle area.

For example, many passenger vehicles have a set of four outer lift points located on the vehicle frame below the doors, and many passenger vehicles may have an additional set of four inner lift points located at structural points (e.g., a rigid bracket, arm, or joint of the frame as opposed to a component of the transmission, engine, exhaust, or suspension) closer to the midline of the vehicle. These lift points may be at different heights and locations to accommodate vehicles of different heights and lengths (e.g., lift points will be spread further apart on a truck or bus as compared to a compact car, and some trucks or sport utility vehicles may have lift points at a higher elevation than those of a sports car or compact car).

As a result, the process of lifting a vehicle often includes positioning the vehicle within the vehicle area, moving lift arms underneath the vehicle, repeatedly visually verifying the locations of the lift points and manually adjusting the lifting members (e.g., by pushing or pulling or, in some cases, by electronic control) until contact is made, and then slowly raising the lifting members while a spotter visually ensures that engagement with the lift points is maintained and that the vehicle does not shift or settle as it raises.

This process can be time-consuming (e.g., requiring repeated adjustment and visual confirmation) or labor-intensive (e.g., requiring one or more visual spotters as well as a lift controller, may require personnel to lie prone to visually spot or position lifting members under the vehicle at ground level), and may be dangerous (e.g., miscommunication between visual spotters and controllers may lead to personnel being struck by the vehicle or lift).

What is needed, therefore, is an improved lifting member and a system and method for positioning the lifting member relative to the lifting points of a vehicle.

### BRIEF DESCRIPTION OF THE DRAWINGS

While the specification concludes with claims that particularly point out and distinctly claim the invention, it is believed the present invention will be better understood from the following description of certain examples taken in conjunction with the accompanying drawings, in which like reference numerals identify the same elements and in which:

FIG. 1 shows a perspective view of an exemplary vehicle lift;

FIG. 2A shows a schematic diagram of an exemplary vehicle spotting system;

FIG. 2B shows a schematic diagram of an exemplary vehicle lift;

FIG. 3 shows an exemplary set of steps that may be performed with the system of FIG. 2A to position a vehicle lift to engage a vehicle;

FIG. 4 shows an exemplary set of steps that may be performed to position a vehicle lift in a manual positioning mode;

FIG. 5A shows an exemplary set of steps that may be performed to position a vehicle lift in an automated local positioning mode;

FIG. 5B shows an exemplary set of steps that may be performed to position a vehicle lift in an automated OEM positioning mode;

FIG. 5C shows an exemplary set of steps that may be performed to position a vehicle lift in an automatic positioning mode;

FIG. 6 shows an exemplary set of steps that may be performed to align an adapter with a lift point using a locator;

FIG. 7 shows an exemplary set of steps that may be performed when positioning lift arms during any of the positioning modes;

FIG. 8A shows an example of an image that may be displayed during a first stage of lift arm positioning;

FIG. 8B shows an example of an image that may be displayed during a second stage of lift arm positioning;

FIG. 8C shows an example of an image that may be displayed during a third stage of lift arm positioning;

FIG. 8D shows an example of an image that may be displayed during a fourth stage of lift arm positioning;

FIG. 8E shows an example of an image that may be displayed during a fifth stage of lift arm positioning;

FIG. 9 shows a perspective view of an exemplary short arm;

FIG. 10 shows an exploded view of the short arm of FIG. 9;

FIG. 11A shows a top-down view of the short arm of FIG. 9 with an adapter extended to a first position;

FIG. 11B shows a top-down view of the short arm of FIG. 9 with the adapter retracted to a second position;

FIG. 12A shows a top-down view of the short arm of FIG. 9 with an exemplary inner arm retracted to a first position;

FIG. 12B shows a top-down view of the short arm of FIG. 9 with the inner arm extended to a second position;

FIG. 13A shows a front perspective view of the inner arm of FIG. 12A;

FIG. 13B shows a rear perspective view of the inner arm of FIG. 12A;

FIG. 14A shows a perspective view of the inner arm of FIG. 12A with portions of a housing removed to show an interior;

FIG. 14B shows a perspective view of the inner arm of FIG. 12A with additional portions of a housing removed to show an interior;

FIG. 15A shows a bottom perspective view of an exemplary housing of the inner arm of FIG. 12A;

FIG. 15B shows an exemplary actuator assembly isolated from the inner arm of FIG. 12A;

FIG. 16A shows a distal end of the actuator assembly of FIG. 15B coupled to an exemplary adapter;

FIG. 16B shows a distal end of the actuator assembly of FIG. 15B with the adapter removed from an exemplary puck;

FIG. 16C shows a perspective view of the adapter;

FIG. 17A shows a perspective view of a locator;

FIG. 17B shows an exploded view of the adapter of FIG. 16C including an optical axis along which the locator is aligned;

FIG. 17C shows a side cross sectional view of the adapter of FIG. 16C including an optical axis along which the locator is aligned;

FIG. 18A shows a perspective view of an exemplary drive assembly;

FIG. 18B shows a side elevation view of the drive assembly of FIG. 18A;

FIG. 19A shows a perspective view of the drive assembly of FIG. 18A partially disassembled;

FIG. 19B shows a bottom perspective view of the drive assembly shown in FIG. 19A;

FIG. 20 shows an exemplary long arm;

FIG. 21 shows an exploded view of the long arm of FIG. 20;

FIG. 22A shows the long arm of FIG. 20 with an adapter retracted to a first position;

FIG. 22B shows the long arm of FIG. 20 with the adapter extended to a second position;

FIG. 23A shows the long arm of FIG. 20 with an exemplary inner arm retracted to a first position;

FIG. 23B shows the long arm of FIG. 20 with the inner arm extended to a second position;

FIG. 24A shows the long arm of FIG. 20 with portions of a housing removed to show the inner arm;

FIG. 24B shows the long arm of FIG. 20 with additional portions of a housing removed to show an actuator assembly;

FIG. 25A shows the long arm of FIG. 20 with the adapter at the first position and the inner arm at the first position;

FIG. 25B shows the long arm of FIG. 20 with the adapter at the second position and the inner arm at the first position; and

FIG. 25C shows the long arm of FIG. 20 with the adapter at the second position and the inner arm at the second position.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

### I. Exemplary Vehicle Lift System

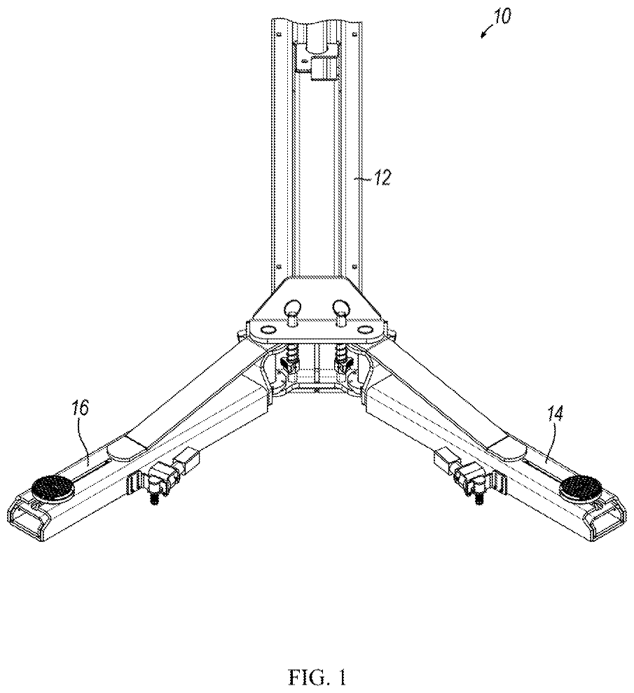

Turning now to the figures, FIG. 1 shows an exemplary lift post (10) that includes a column (12), and a pair of lift arms (14, 16). The lift arms (14, 16) may support varying types of movements, including rotating relative to the column (12) and ascending and descending the column (12), as well as various adjustments (e.g., extending, retracting, raising, lowering) to the lift point adapter, with such capabilities being dependent upon the particular implementation of lift arm. The lift post (10) may be used in opposing pairs with a vehicle position between the two vehicle lift posts (10). The lift post (10) may be operated to position each of the lift arm (14, 16) underneath lift points of a vehicle such that they make contact and engage with the frame of the vehicle, allowing it to be raised to a desired height as the lift arms (14, 16) of a pair of the lift post (10) ascend the column (12).

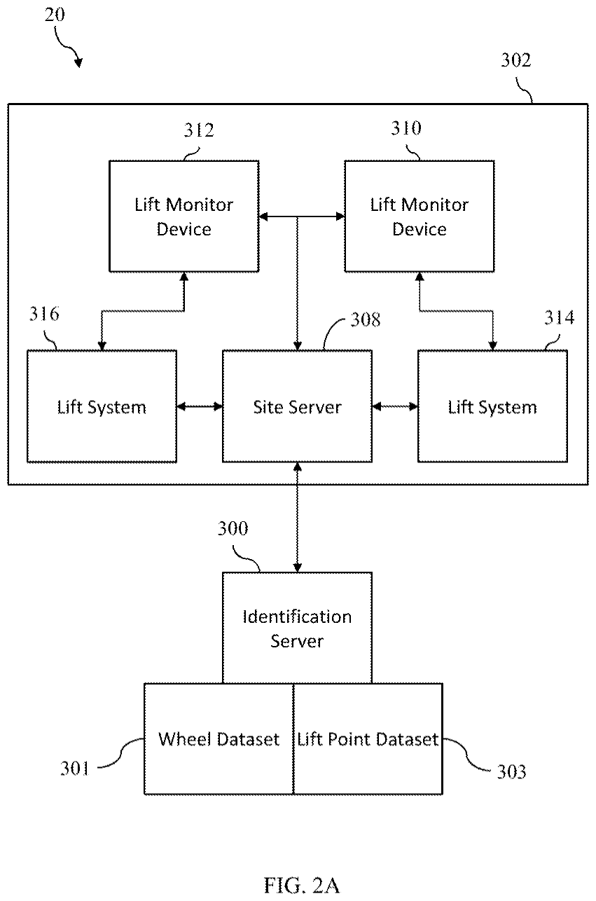

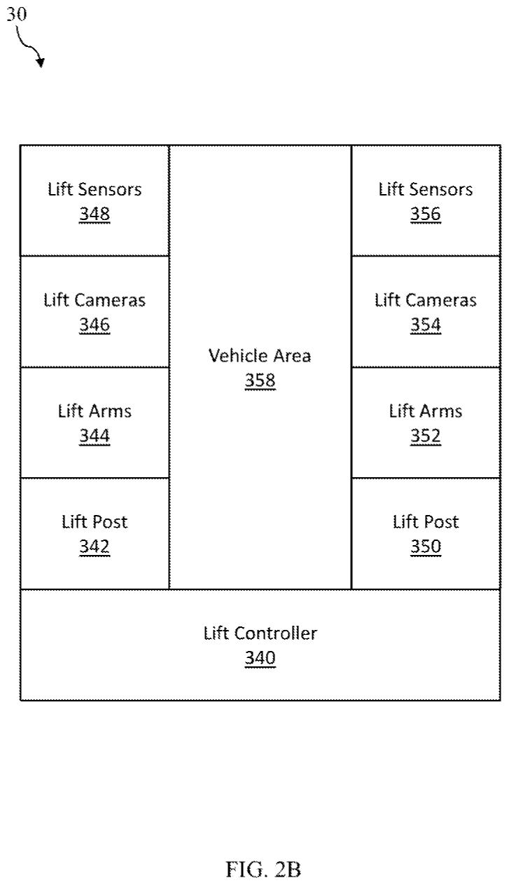

A lift such as that shown in FIG. 1 may be partially or full automated to aid in safely engaging and lifting a vehicle using a system such as that shown in FIG. 2A, which shows a schematic diagram of an exemplary lift automation system (20). The lift automation system (20) comprises an identification server (300) that is in communication with one or more user sites (302). The user site (302) may be a user location or installation such as a vehicle service garage capable of servicing one or more vehicles. The user site (302) may comprise a site server (308) that is in communication with the identification server (300), and one or more lift systems (314, 316) and lift monitor devices (310, 312). A user of the lift automation system (20) may have one or more user sites such as the user site (302) (e.g., separate buildings each capable of servicing one or more vehicles), or it may have a single user site such as the user site (302) that is spread across separate buildings (e.g., a particular user may have a single site server (308) that is in communication with lift systems (314, 316) that are located in different buildings).

The identification server (300) may be one or more physical or virtual servers or server environments capable of storing, processing, and transmitting various types of information via the internet or another network. The identification server (300) stores or is in communication with other servers or databases that are configured to store a wheel dataset (301), comprising data in various forms that may be used to aid in the automatic detection and identification of vehicle wheels, and a lift point dataset (303), comprising data in various forms that may be used to aid in the automatic detection and identification of vehicle lift points, as will be discussed in more detail below.

The site server (308) may be one or more physical or virtual servers or server environments capable of storing, processing, and transmitting information via the internet or another network, and may also be in communication with one or more lift systems (314, 316) and one or more lift monitor devices (310, 312). The site server (308) may store sets and subsets of information from the wheel dataset (301) and the lift point dataset (303) that it receives via the identification server (300) or another device. The site server (308) may also provide site performance information to the identification server (300) to allow for the growth and refinement of the wheel dataset (301) and the lift point dataset (303), as will be discussed in more detail below.

The lift system (314, 316) may be any of a variety of vehicle lifts that are compatible with and may benefit from automatic positioning of lifting members at vehicle lift points. The lift monitor device (310, 312) may be, for example, a smartphone, tablet, laptop computer, desktop computer, kiosk device, or other proprietary device capable of displaying information, receiving user inputs, processing and storing information, communicating with other devices, and displaying information to a user. The lift monitor device (310) is in communication with the lift system (314) and allows a user of the lift monitor device (310) to view information (e.g., textual information describing the lift as well as visual data associated with the lift), interact with, and control the lift system (314), as will be described in more detail below.

Variations on lift automation system (20) shown in FIG. 2A exist and will be apparent to one of ordinary skill in the art in light of this disclosure. For example, in some implementations, identification server (300) and site server (308) may be the same server or environment, or identification server (300) may communicate directly with the lift system (314, 316) and the lift monitor device (310, 312). In some implementations, site server (308), lift monitor device (310, 312), or both may be components of (e.g., integrated with or connected to in a one-to-one correspondence) the lift system (314, 316).

To provide more information on lift systems, FIG. 2B shows a schematic diagram of an exemplary vehicle lift system (30), such as the lift system (314), that is usable with the lift automation system (20). The lift system (30) comprises a vehicle area (358) in which a vehicle may be positioned in order to be interacted with by the lift system (30). While the disclosed technology could function with a variety of vehicle lifts, for the sake of clarity and discussion, this disclosure will focus on describing two-post, frame-engaging vehicle lifts (e.g., lifts having lifting members that contact multiple lift points on a vehicle's frame and lift the vehicle from a resting point in the vehicle area (358)).

A lift controller (340) may be a computing device (e.g., a separate device connected to other components of the lift system (30) or an integrated control system, which may include a processor, memory, user interface, data interface, or other components) that is operable to control various aspects of the lift. For example, the lift controller (340) may, based on user inputs or automatically, provide electronic signals to cause a lift post (342, 350) to raise or lower lift arms or to cause one or more lift arms (344, 352) extending from a lift post to rotate, extend, retract, raise, or lower adapters and cause other mechanical movement by the lift arms (344, 352). The lift controller (340) may also receive information from one or more lift cameras (346, 354) and lift sensors (348, 356) captured from the vehicle area (358), which may be used by one or more of the lift controller (340), the site server (308), or the identification server (300) to influence the behavior and performance of the lift automation system (20), as will be discussed in more detail below. The lift cameras (346, 354) and lift sensors (348, 356) may be collectively referred to herein as lift area detectors, as they allow the lift controller (340) to detect and receive information on physical characteristics of the vehicle area (358). The lift controller (340) may be comprised of a network of controllers and/or sub-controllers in communication with each other. For example, the lift controller (340) could be comprised of a main controller in proximity to an optimal user location, in communication with sub-controllers located at each lift post (342) in close proximity to the lift cameras (346, 354) and lift sensors (348, 356), with each controller and/or sub-controller having its own processors and memories or being operated by a set of centralized processors and memories.

The lift cameras (346, 354) may be positioned in various locations, including on the lift post (342, 350) and directed at the vehicle area (358) to capture still images and/or video (referred to generically herein as “image”) data from a vehicle (e.g., vehicle and wheel size, shape, position) or vehicle area (e.g., the presence of a technician or other person within the vehicle area), on the lift arms (344, 352) and directed at the vehicle area (358) to capture image data from a vehicle (e.g., profile views of lift point locations), within an adapter of the lift arms (344, 352) to capture image data from a vehicle (e.g., plan views of lift point locations), as well as other positions and objectives. The lift sensors (348, 356) may be positioned in various locations, including on the lift post (342, 350) and directed at the vehicle area (358) to capture data such as proximity of various portions of the vehicle relative to the mounting points of the lift sensors (348, 356). Placement and uses of lift cameras (346, 354) and lift sensors (348, 356) will be described in more detail below. As will be apparent to one of ordinary skill in the art in light of this disclosure, variations on the lift system (30) of FIG. 2B exist. For example, not all implementations will have multiple lift cameras (346, 354) or multiple lift sensors (348, 356), and some implementations may have other devices or sensors performing similar functions (e.g., a camera may be configured to act as a proximity sensor, a camera may be configured to detect four-corner vehicle proximity by placement of QR codes or other digital identifiers at corners of the vehicle, wireless triangulation may be used to detect positions of BLUETOOTH transceivers placed at corners of the vehicle or near lift points).

As yet another variation, it should be understood that the lift system (30) may have varying types of lifts and lift configurations, as has been described. For example, the lift system (30) may not be a two-post lift having posts such as the lift posts (342, 350), or may be a type of vehicle lift that does not have lift arms such as the lift arms (344, 352). Some implementations of the lift system (30) may instead or additionally include one or more of an in-ground lift that lifts a vehicle by its wheels or by a set of repositionable (e.g., along a single axis parallel to the vehicle) lifting carriages, a set of rolling jacks, a scissor or accordion lift, sets of mobile lift columns (e.g., two or more mobile posts that may be rolled into place at lifting points or wheels of a vehicle). In some implementations, one or more of the features of the vehicle lift system (30) may also be applied in other areas where vehicles are stored, lifted, or carried. For example, a towable car carrier that is designed to carry one or more vehicles may have manually or automatically adjustable ramps and vehicle pads that may be operated when loading vehicles for transport. Devices such as the lift sensors (348, 356), lift cameras (346, 354), and lift controller (340) may be combined with such a vehicle carrier and configured to provide one or more of the features or functions described herein, such as aiding in the safe placement of vehicles. In this manner, the sensors (348, 356) and lift cameras (346, 354) may be widely distributed across a plurality of vehicle lifts or related system and leveraged to gather images and other sensor data through numerous real-world uses as a distributed sensor network, which data itself can be used to develop and refine automated processes for identifying vehicles and portions of vehicles.

As has been discussed, lift systems may also have differing designs and layouts other than those shown two-post lift system (30). For example, other lift systems may have four posts, may be drive-on style lifts, or may have other configurations.

### II. Exemplary Methods for Vehicle Lift Positioning

It may be advantageous to provide a vehicle lift that is completely or partially autonomous in operation in order to improve the speed, efficiency, and safety of vehicle lift operations. This is especially true of initial positioning of the vehicle relative to the lift arms and positioning of the lift arms relative to lift points of the vehicle. This step is commonly performed manually using multiple readjustments and visual confirmations, and often requires that a technician enter the lift area (358) and inspect below the vehicle, often from a prone or partially prone position on the ground. Where a single technician is both adjusting the lift arms and spotting their position relative to the vehicle lift points, this can be an especially inefficient, error prone, and potentially dangerous process.

FIG. 3 shows an exemplary set of steps (320) that may be performed with a system, such as the system (20) of FIG. 2A, to position a vehicle lift to engage a vehicle using one or more partially or fully autonomous positioning modes. Initially, the vehicle may be identified (322), in addition to any lift modes that are available and supported for that vehicle. Vehicle identification may be performed by manual input from a user (e.g., selecting a year, make, model, VIN number, etc.) or may be performed automatically based on image recognition of the vehicle (e.g., with an image captured by the lift cameras (346, 354), an image capture of a VIN or other information from the vehicle, identifying data received from an engine control unit of the vehicle, or based on information from other sources. Available lift modes may be based on the identified vehicle, as well as upon the configuration of a particular vehicle lift (e.g., some lifts may lack the required hardware or software configurations to operate in some lift modes). As an example, some automatic lift positioning modes may only be available for certain vehicles for which OEM lift point specifications are available, and so may only be available for use with vehicles from certain manufacturers that make such data available.

The system may then locate (324) the vehicle within the lift area (358) based on feedback from the lift cameras (346, 354), the lift sensors (348, 356), or both. Vehicle location may be performed using one or more of image capture and recognition, LIDAR or other proximity-sensing technologies, weight sensors or pressure plates, or other devices. Additional examples of vehicle location (324) are described in U.S. Pat. No. 9,908,764, the disclosure of which is hereby incorporated by reference in its entirety.

The system may then allow a user to select one of the available lift modes. Once a lift mode is selected, the system may initiate performance in that lift mode, which may include automatic pre-positioning of lift arms, manual positioning and confirmation interactions from users, automatic fine tuning and final positioning of lift arms, as well as other steps. A variety of lift modes may be supported and may include, for example, an automatic positioning mode (326), an OEM positioning mode (328), a local positioning mode (330), and a manual positioning mode (332), each of which are described in more detail below. Once operation in the selected lift mode is completed, the lift arms will be positioned to engage the lift points of the vehicle and the lift may be operated to lift (334) the vehicle. Lifting (334) of the vehicle may be performed manually or automatically and may include additional safety features such as disabling of lift functions until positioning is complete, disabling of lift functions until manual confirmation of engagement with lift point is completed, or other features.

The system may also gather various information during lift operations and, upon completion of operation in a lift positioning mode, may store or provide data to various other systems that may be used to refine and improve future lift operations. As an example, this may include storing captured images, image analyses, and user confirmations to improve feature recognition processes, capturing the coordinates or positions of lift points on a vehicle (e.g., such as where a vehicle has aftermarket lift points added that are used instead of OEM lift points), or other data. Such data may be used to update (336) and refine global datasets that are usable by a variety of vehicle lifts and across a variety of customers or users. Such data may also be used to update (338) and refine local datasets that are usable by a particular lift, or by a particular facility with multiple lifts. As local and global datasets are updated (336, 338) and refined, such information may be immediately available, or available upon distribution, and may be used during performance in various positioning modes (326, 328, 330, 332).

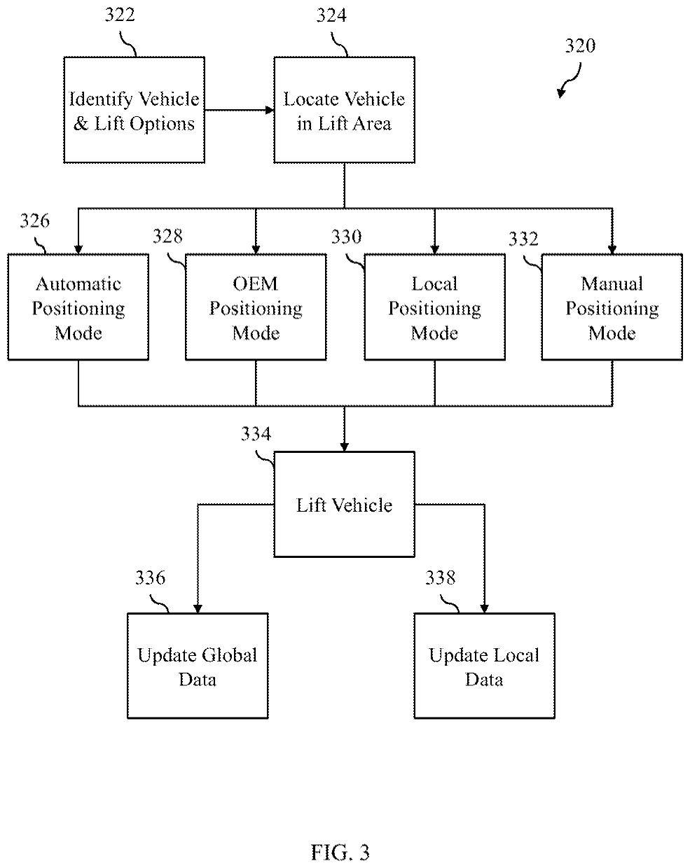

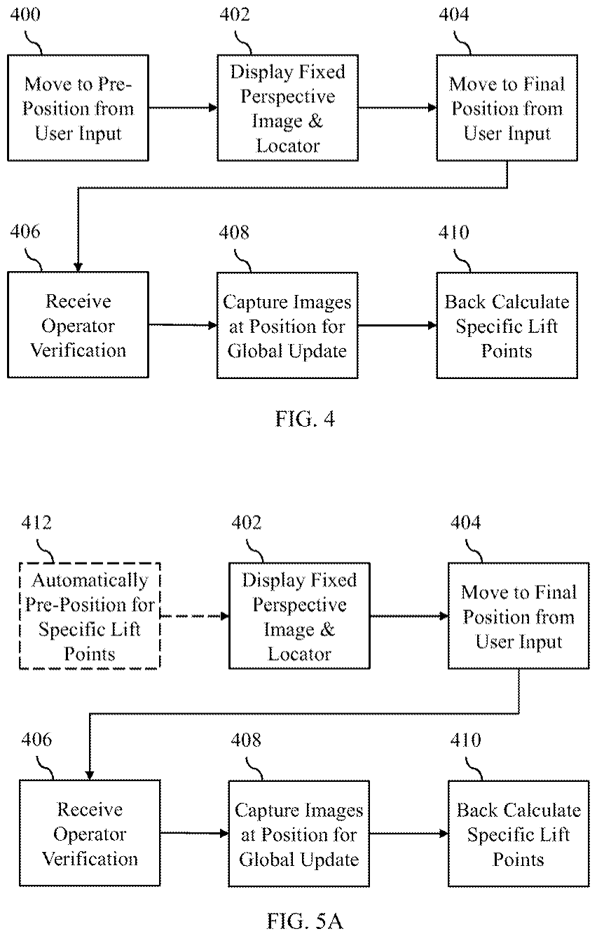

FIGS. 4-8 show examples of steps that may be performed during operation in various positioning modes, such as those referenced in FIG. 3 above. FIG. 4 shows an exemplary set of steps that may be performed to position a vehicle lift in a manual positioning mode, such as the manual positioning mode (332). When this mode is selected, the system may allow a user to manually move and pre-position (400) the lift arms using the lift controller (340) or another user interface. Manual pre-positioning (400) may include positioning the lift arms so that the respective adapters are near the vehicle, but not immediately below it, or not immediately below a corresponding lift point.

After manual pre-positioning (400), the system will display (402) an image or video feed from a camera matched to the moving lift arm's perspective on a user device or display available to the user (e.g., on a display of the lift controller (340)) and may additionally provide an optical locator on the vehicle to aid in manual final positioning (404) of the lift arms and adapters to engage the lift points. In some implementations, the system may be configured to display (402) the images and locator during pre-positioning (400), during movement (404) to the final position, or both.

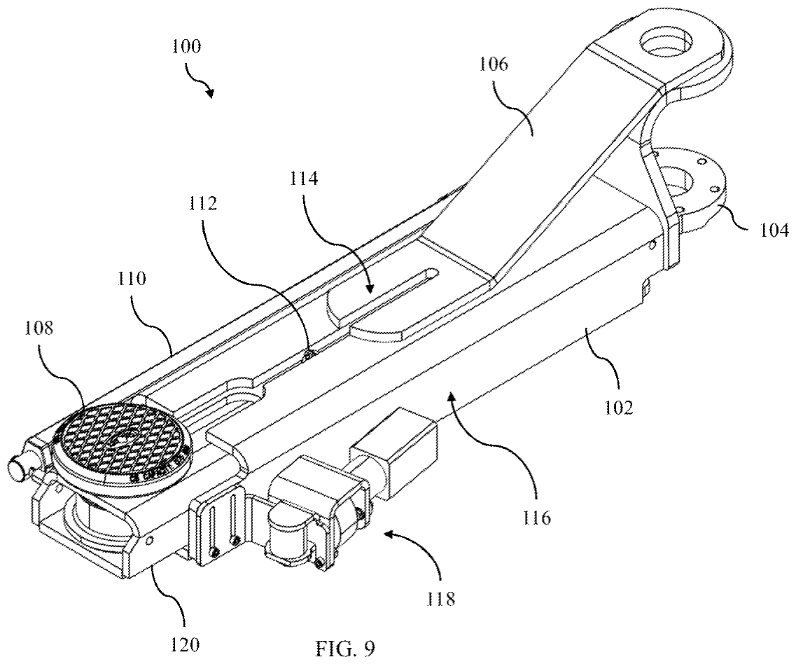

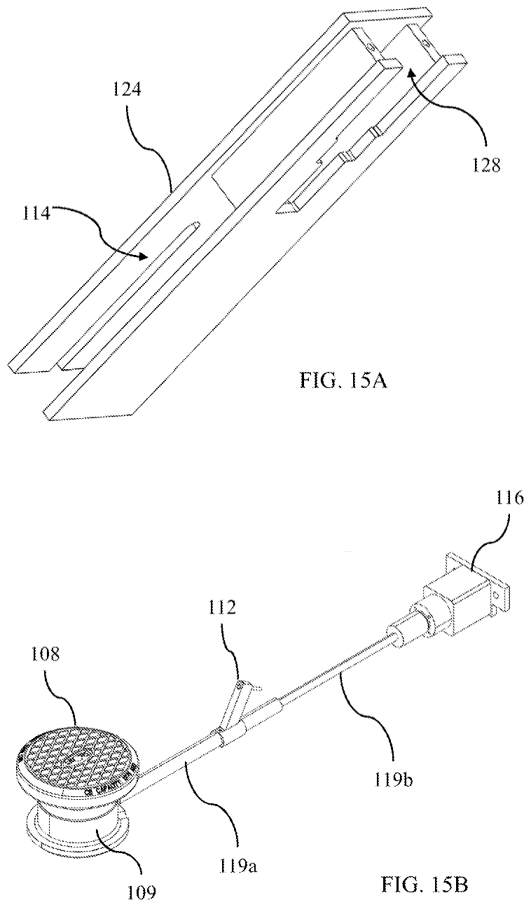

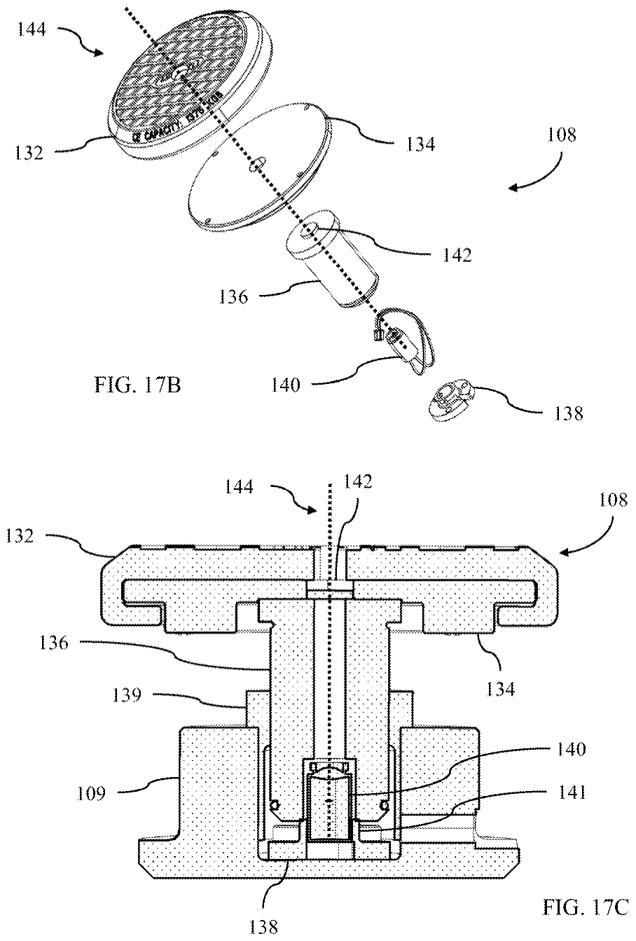

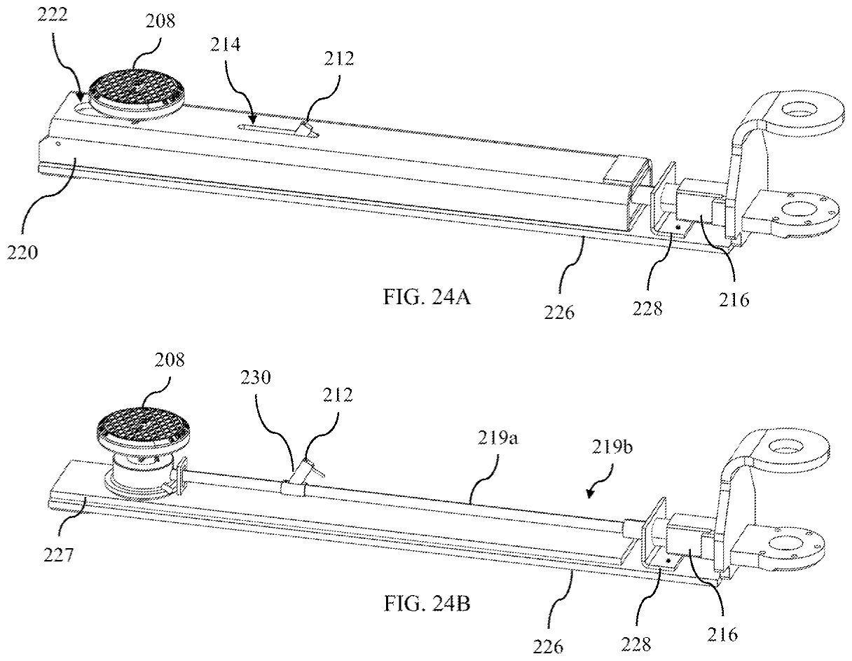

As will be discussed in more detail below in the context of FIGS. 9-25, the images may be provided by a camera that has a static relationship to the lift adapter portion of its respective lift arm (e.g., a camera (112, 212) as shown in FIGS. 15B and 24B), while the optical locator may be provided by a laser-emitting device (e.g., a locator (140) as shown in FIGS. 17B and 17C) that projects a laser beam upwards from the adapter. By displaying (402) the images or video from the camera during manual positioning of a lift arm, the system provides a technician with images having a field of view that includes the adapter of the lift arm as a static portion, as well as the area around the adapter (e.g., including the lift point) as the adapter is positioned. The projected optical locator may be used to aid in judging the depth and true position of the adapter relative to a lift point above it based only upon two-dimensional images.

Once movement (404) to the final position has been manually completed by the user, the system may receive (406) verification of the positioning of the lift arm adapters relative to the vehicle lift points from the user based on direct visual inspection and/or review of the displayed (402) images. This may include providing a user prompt or other software interface that instructs the user to verify and manually confirm the positioning, such as a confirm button placed near the displayed (402) image. After confirmation is received (406), the system may capture (408) one or more images to be provided as part of a global dataset update. The captured image may include one of the displayed (402) images captured at the time of confirmation and may be provided to the global dataset as an example of an image that has been confirmed by a user to contain a properly positioned lift arm adapter and vehicle lift point, which may be used in future image recognition processes for identifying adapters, lift points, or ideal relative positions of both.

The system may also back-calculate (410) the positions of the vehicle lift points based on the vehicle's known position within the lift area (358) and the set of manual inputs from the user during pre-positioning (400) and movement (404) to the final position to position the adapters at the lift points. As an example, where the vehicle has been located (324) as described in FIG. 3, the vehicle's position and orientation within a coordinate space are known. With each lift arm and adapter starting at a neutral or origin position (e.g., x=0, y=0), its final position within the same coordinate position can be determined based on data such as the user inputs, motor or position sensors on the motors driving repositioning of the adapter and lift arm, or other similar data. For example, a series of user inputs over several minutes may rotate, extend, and retract a particular adapter numerous times until a final position is achieved. The net result of those user inputs may be tracked and resolved to determine a current position of the adapter in the coordinate space (e.g., the adapter center is now located at x=65, y=50, where each unit is a centimeter).

The back-calculated (410) positions of the lift points may then be stored and associated with that particular vehicle or that model of vehicle during a global update (336), local update (338), or both. This data may be useful for subsequent lift operations involving the same vehicle or the same type of vehicle, as the lift point positions will already be known with some confidence, which may allow for automated pre-positioning, final positioning, or both. In sequence or in parallel with image capture (408) and back-calculation (410), the system may enable the lift for lifting (334) of the vehicle and then perform any available data updates, as have been described.

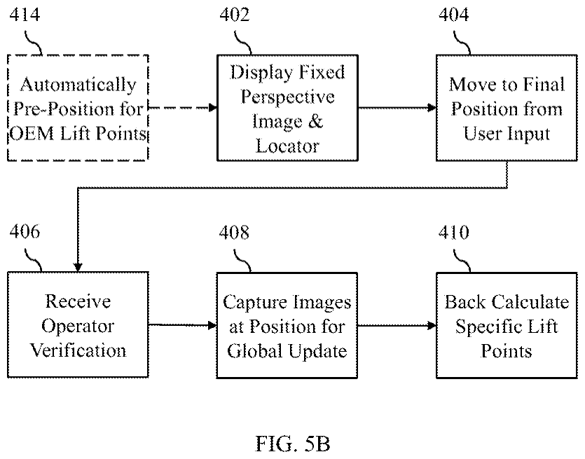

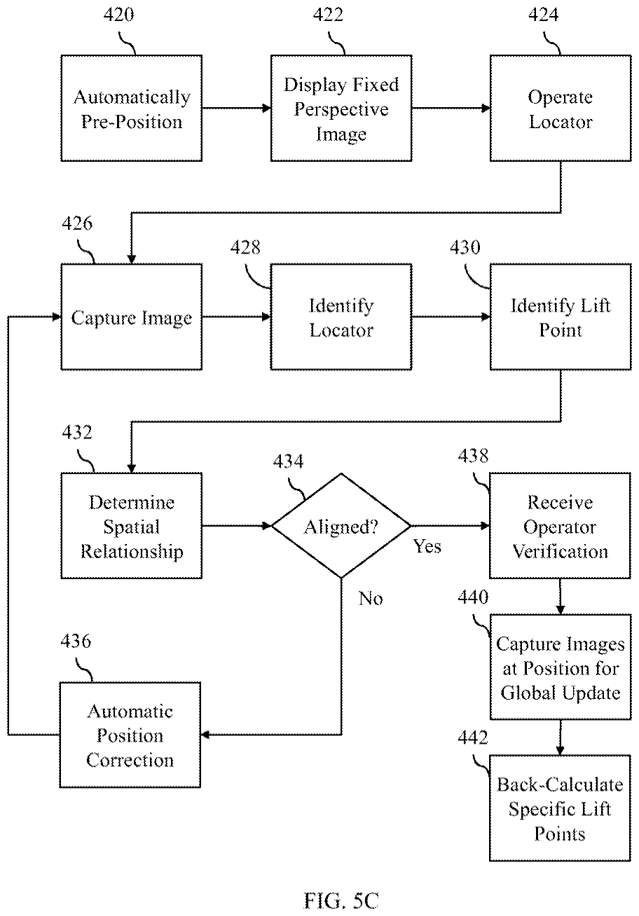

As another example of steps performed during operation in a lift positioning mode, FIG. 5A shows an exemplary set of steps that may be performed to position a vehicle lift in an automated local positioning mode. Local positioning mode may be available when the vehicle has been located (324) within the lift area (358), the vehicle has been identified (322), and when information is available indicating the locations of lift points for that particular vehicle or type of vehicle (e.g., such as the locations of the lift points determined during back-calculation (410) as part of a manual positioning process). In some implementations, local positioning mode may be available for any vehicle that is first lifted in manual positioning mode, since the inputs and conditions determined during manual positioning mode can be used to train the system for future use with that vehicle.

In local positioning mode, the system may operate the lift arms (e.g., rotating and extending or retracting lift arms, extending or retracting adapters, etc.) in order to automatically pre-position (412) the lift arms and adapters for the specific lift points of a vehicle. The automatic pre-positioning (412) may position the adapters at or near an acceptable location for engaging with the vehicle lift points. Automatic pre-positioning (412) may be performed based on the vehicle's known position (e.g., within a coordinate system or other virtual mapping) and the known positions of the vehicle's lift points (e.g., within a coordinate system or other virtual mapping). As an example, lift point locations may be determined based on back-calculated (410) data or manual configuration of the vehicle's lift points (e.g., based on measurement by a technician from each edge of the vehicle, or from the midline of the vehicle). Automatic pre-positioning (412) may also include first moving each movable component of the lift arms to an origin or neutral position within a coordinate system or other virtual mapping, then operating the motors to rotate and extend components until the adapter is positioned at the pre-position destination. The adapter's current position during automatic pre-positioning (412) may be determined based on tracking and/or sensing motor operations (e.g., angle of rotation for an electric motor that rotates a lift arm, distance of extension of a linear actuator that extends the lift arm) or based on independent sensor data such as images capture and analysis, LIDAR mapping, or motion or proximity sensor data.

Once automatic pre-positioning (412) has been performed in local positioning mode, the subsequent steps are similar to those performed in manual positioning mode, and may include displaying (402) the image and optical locator, providing control to a technician and moving (404) the lift arms and adapter to a final position based on user input, receiving (406) verification from the operator that the adapter is in position to engage the lift point, capturing images (408) at the position of engagement to use for local and global data updates, and back-calculation (410) of the locations of the specific lift points that are engaged. In local positioning mode, back-calculation (410) of lift points that are engaged may reinforce and/or update local data for that vehicle or type of vehicle for use in future local positioning mode operations. Where the back-calculated locations match or are within a configured threshold of those previously stored (e.g., to account for variances due to build tolerance or mild wear), the system may track subsequent confirmations of those locations over time and begin to develop a confidence rating in the positions of lift points for that vehicle and vehicles of that type. Where the back-calculated locations do not match those previously stored, the system may analyze historic back-calculations and lift point locations for that vehicle and type of vehicle to determine whether the change is vehicle-specific, vehicle type-specific, or erroneous. In such an implementation, the system may develop a historic database of lift point locations over time that can account for aftermarket modifications to a vehicle that reposition lift points, or new vehicle models that reposition lift points, and will be able to adapt to support both historic locations and new and changing locations.

As another example of a positioning mode, FIG. 5B shows an exemplary set of steps that may be performed to position a vehicle lift in an OEM positioning mode. OEM positioning mode may be available when the vehicle has been located (324) within the lift area (358), the vehicle has been identified (322), and specification information is available for the vehicle indicating the locations of lift points for that particular type of vehicle (e.g., from the original equipment manufacturer or another source). In some implementations, OEM positioning mode may be available for any type of vehicle that has been associated with OEM or aftermarket measurements and specifications for lift point locations, and that has not been modified from its OEM condition in a way that has changed or repositioned the original lift points for the vehicle.

In OEM positioning mode, the system may operate the lift arms (e.g., rotating and extending or retracting lift arms, extending or retracting adapters, etc.) to automatically pre-position (414) the lift arms and adapters to align with the lift points for that type of vehicle. The automatic pre-positioning (414) may position the adapters at or near an acceptable location for engaging with the vehicle lift points. Automatic pre-positioning (414) may be performed based on the vehicle's known position (e.g., within a coordinate system or other virtual mapping) and the known positions of the vehicle's lift points (e.g., within a coordinate system or other virtual mapping) based on the OEM or aftermarket specification. Automatic pre-positioning (414) may also include first moving each movable component of the lift arms to an origin or neutral position within a coordinate system or other virtual mapping, and then operating the motors to rotate and extend components until the adapter is positioned at the pre-position destination. The adapters current position during automatic pre-positioning (414) may be determined based on tracking or sensing motor operations (e.g., angle of rotation for an electric motor that rotates a lift arm, distance of extension of a linear actuator that extends the lift arm) or based on independent sensor data such as image capture and analysis, LIDAR mapping, or motion or proximity sensor data.

Once automatic pre-positioning (414) has been performed in OEM positioning mode, the subsequent steps are similar to those performed in manual positioning mode, which may include displaying (402) the image and optical locator, providing control to a technician and moving (404) the lift arms and adapter to a final position based on user input, receiving (406) verification from the operator that the adapter is in position to engage the lift point, capturing images (408) at the position of engagement to use for local and global data updates, and back-calculating (410) the specific lift points that are engaged. In OEM positioning mode, back-calculation (410) of lift points that are engaged may be used to reinforce and/or update local data for that vehicle or type of vehicle for use in future OEM or local positioning mode operations. Where the back-calculated locations match or are within a configured threshold of the OEM-specified locations, the system is able to confirm that the OEM specifications are accurate and that the particular vehicle has not been modified in a way that repositioned the lift points relative to other dimensions of the vehicle (e.g., movement of the lift points, or modification of the overall dimensions of the vehicle resulting a relative movement of the lift points). Where the back-calculated locations do not match those previously stored, the system may flag the OEM specifications as potentially erroneous or, where historic data is available for numerous vehicles of that type, may flag that particular vehicle as having been modified in a way that renders the OEM specifications no longer accurate.

In such an implementation, the system may develop a historic database of lift point locations over time that can account for aftermarket modifications to a vehicle that reposition lift points, or new vehicle models that reposition lift points, and will be able to adapt to support both historic locations and new and changing locations. As an example, where a particular vehicle has been flagged due to a mismatch of the actual lift points and the OEM-specified lift points, future uses of the system for the vehicle may indicate that OEM positioning mode is no longer available and that local positioning mode should be used instead.

As another example of a positioning mode, FIG. 5C shows an exemplary set of steps that may be performed to position a vehicle lift using an automatic positioning mode. Automatic positioning mode may be available when the vehicle has been located (324) within the lift area (358), the vehicle has been identified (322), and information is available that identifies the lift points for the vehicle (e.g., OEM specification data as described in relation to the OEM positioning mode of FIG. 5B, back-calculated (410) data from another positioning mode, or other data). In some implementations, automatic positioning mode may be available for any vehicle or type of vehicle that has been associated with OEM or aftermarket measurements and specifications for lift point locations, including back-calculated (410) locations. In some implementations, automatic positioning mode may be available for vehicles only when the lift point positions are determinable with a level of confidence in their accuracy above a certain threshold. As an example, OEM specifications describing lift point locations may be considered accurate enough for automatic positioning immediately, or after one or several uses of the OEM specifications during OEM positioning mode. Aftermarket specifications (e.g., manual measurements, back-calculated (410) measurements) may be considered accurate enough for automatic positioning mode only after a number of uses in manual and/or local positioning mode that confirm their accuracy for a particular vehicle or type of vehicle.

In automatic positioning mode, the system may automatically (420) pre-position the lift arms and adapters based on the vehicles known position in the lift area (358) and the known positions of the vehicle lift points. As with prior examples, the pre-position destination may be at or near an acceptable position for actual engagement with the lift points. The system may display (422) an image to an operator via a user device or the lift controller (340) and may operate (424) the locator (e.g., a laser) to project an optical locator onto the target (e.g., a lift point or a position on the underside of the vehicle proximate to the lift point).

The system may also capture (426) an image (e.g., using a camera (112, 212) such as that shown in in FIGS. 15B and 24B) from the perspective of a point that has a view of the region of the lift point. In some implementations, the position and capabilities of the camera (112, 212) are configured to provide a particular perspective relative to the adapter of the lift arm, regardless of any rotation or extension of the lift arm or extension of the adapter itself. Automatic pre-positioning (420) and operation (424) of the locator may result in images from the perspective showing the adapter (e.g., typically occupying the bottom or edge(s) of the image), a lift point of the vehicle (e.g., typically occupying an upper portion or center of the image), and the projected optical locator (e.g., typically projected onto the lift point or other position under the vehicle). The system may then perform one or more feature recognition analyses on the captured image in order to identify (428) the optical locator and identify (430) the lift point.

The optical locator may be identified (428) based on an analysis of the image for the particular characteristics of the optical locator. As an example, where the optical locator is a projected laser focal spot, the image may be analyzed for color and/or light characteristics matching a laser focal spot, and the image may further be analyzed to determine whether the shape of the focal spot indicates projection onto a flat surface, onto an angled surface, or across an edge of an object. As another example, the locator may also project an encoded light pattern such as a barcode, QR code, geometric shape, pattern over time, or other light grid or pattern that is readily detectable within an image using feature recognition techniques.

The lift point may be identified (430) based on an analysis of the image for characteristics of the lift point or for characteristics of a marker or physical tag placed on the lift point. As an example, the currently captured image may be compared to a plurality of similar images as part of a machine-learning feature recognition process in order to identify the lift point based on its size, shape, and position relative to other objects in the image. The plurality of similar images may be provided from the global dataset, local dataset, or both, and may be maintained as part of updating (336, 338) those datasets. In some scenarios, the comparison images may be images captured for the same exact vehicle or the same type of vehicle and have been captured and confirmed by operators in previous lift scenarios.

The system may then determine (432) the spatial relationship between the identified (428) optical locator and the identified (430) lift point and determine whether the locator and lift point are aligned (434). This may include determining whether the optical locator is positioned on an underside of the lift point within the captured (426) image. Where the lift point is a ridge or rib this may also include determining whether a laser locator is projected and substantially centered on the ridge (e.g., projecting onto both the underside of the ridge and along the side of the ridge, which is typically only a few millimeters thick). Where the lift point is a puck, cup, or other type, this may include determining whether a laser locator is projected onto a flat surface and substantially centered on the structure based on the shape of the projected focal spot.

In some implementations, the system may, after identifying (430) the lift point, define a lift envelope that contains the lift point within the image, and which may also be displayed (422) as part of the image (e.g., such as a colored box surrounding the lift point). When determining alignment (434), the system may consider the adapter to be aligned with the lift point when the optical locator is identified (428) as being contained within the lift envelope, and so the lift envelope may be configured and defined for each lift point in order to define the areas on which the optical locator may be projected when aligned (434).

Where the optical locator is not aligned (434) with the lift point, the system may automatically correct the position (436) of the lift arms and/or adapter in order to bring the optical locator into alignment with the lift point. These corrections (436) may occur one or more times and may include rotation of the lift arm, extension or retraction of the lift arm, retraction or extension of the adapter, or other adjustments. The corrections (436) may be determined based on the determined (432) spatial relationship and may be performed continuously while subsequent images are captured (426), objects identified (428, 430), and alignment is determined (434). As an example, where the optical locator is identified (428) as being offset to the left of the identified (430) lift point, the lift arm may rotate to the right while continuously capturing images (426) and reassessing alignment (434) until alignment is achieved.

When the system determines that the optical locator and lift point are aligned (434), the system may prompt a user for and receive (438) verification from the operator that the adapter is properly positioned. This may be based on visual inspection, viewing of the displayed (422) image, which may also contain visual indications of the identified optical locator, identified lift point, lift envelope, etc. The system may also allow manual control of the lift arms at this point in case the user does not verify (438) the positioning.

After receiving (438) operator verification, the system may capture (440) images at the current position for updating local and global datasets and may back-calculate (442) the positions of the lift points as has been previously described. Back-calculated (442) lift points may be used to verify, reinforce the confidence in, and/or update local and global lift point positions and datasets, as has been previously described. As an example, where the back-calculated (442) lift points do not match the previously known lift points, the system may cause automatic positioning mode to be unavailable for that vehicle until subsequent data from lifting the vehicle in manual or local positioning mode reaches a required confidence level (e.g., after one or several subsequent verifications of the new lift point locations).

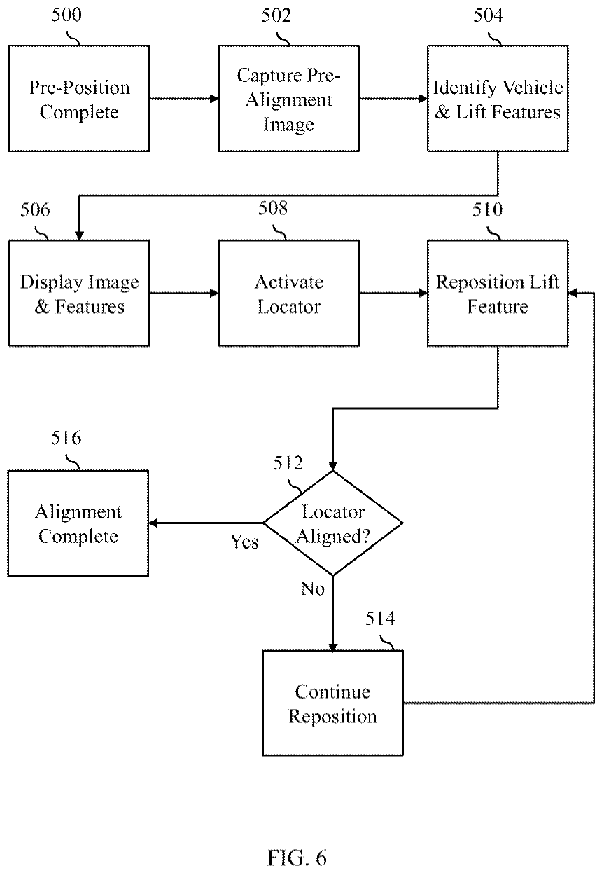

While an example of automatically positioning the adapter to achieve alignment with lift points has been described, other examples exist. For example, FIG. 6 shows an exemplary set of steps that may be performed to align an adapter with a lift point using a locator. After pre-positioning is complete (500), the system may capture (502) a pre-alignment image using the camera. The system may perform a feature recognition function to identify one or more features of the vehicle and the vehicle lift, which may include identifying wheels, identifying lift points, identifying exhaust components or other vehicle components on the underside of the vehicle, identifying the lift adapter, and identifying other objects in the image. Identified (504) objects may be marked in the pre-alignment image with boxes, circles, or text indicating their status, and may also be marked with a score or percentage indicating the system's confidence in the identification (e.g., displaying that a lift point has been identified within the image with a 99% confidence).

The system may also activate (508) a locator (e.g., such as a laser) to project an optical locator onto the underside of the vehicle from the center of the adapter and may perform additional image analyses to identify the optical locator within the image relative to other identified (504) features. Based on the relative positions, the system may then reposition the lift feature (e.g., the adapter) until the identified lift feature, the optical locator, or both align (512) with an identified vehicle feature (e.g., the lift point). Where alignment (512) has not yet been achieved, the system may continue (514) the automatic repositioning by increments until the optical locator is aligned (512), at which time the alignment is complete (516) and the operator verification may be requested and received (438).

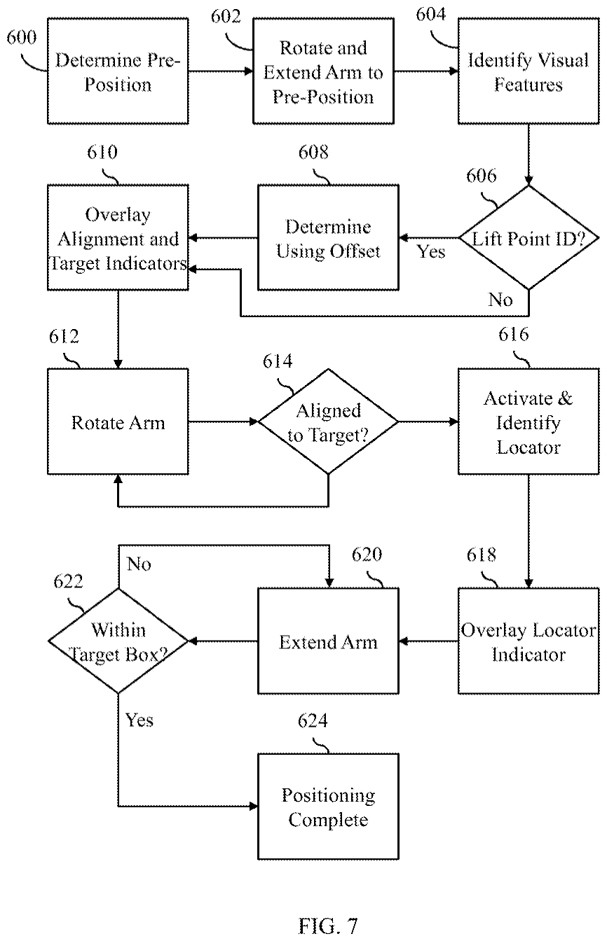

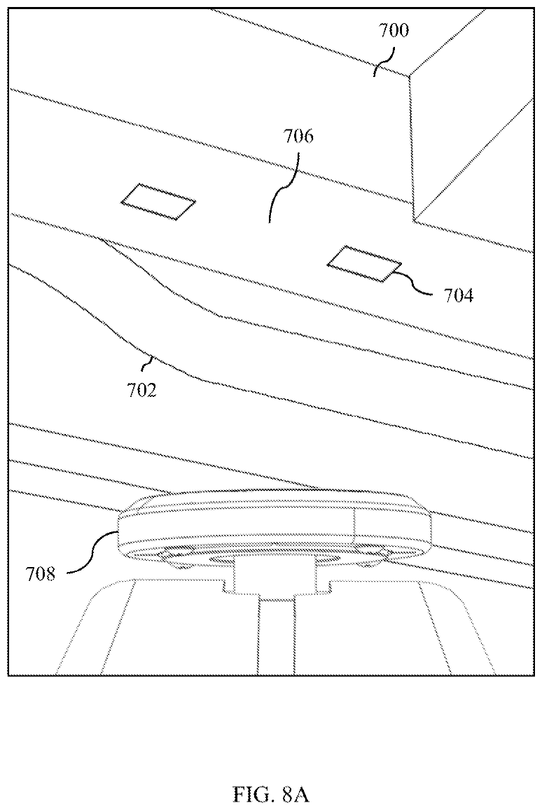

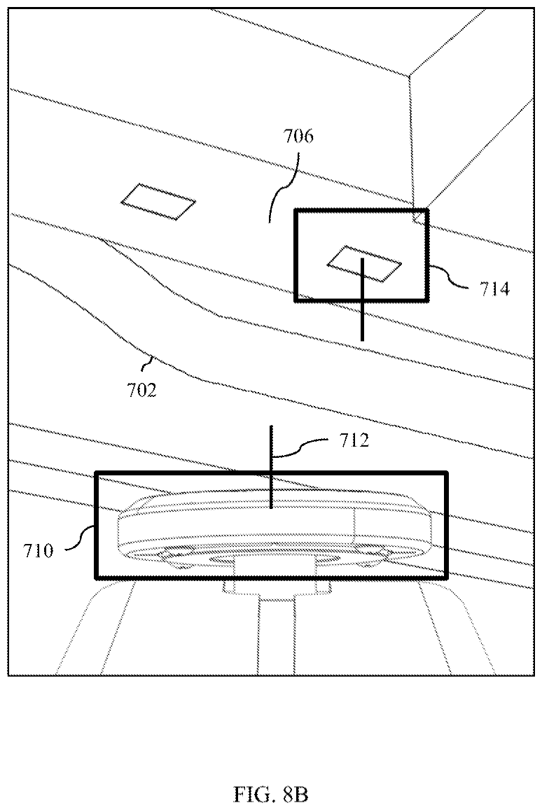

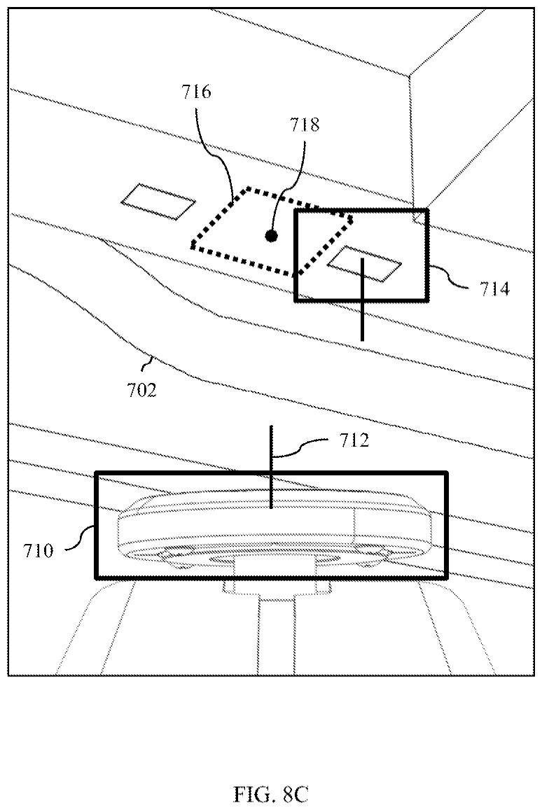

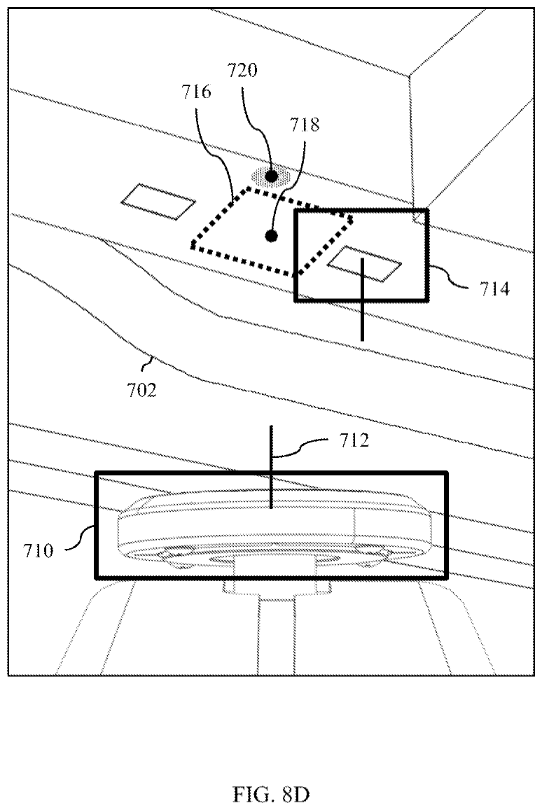

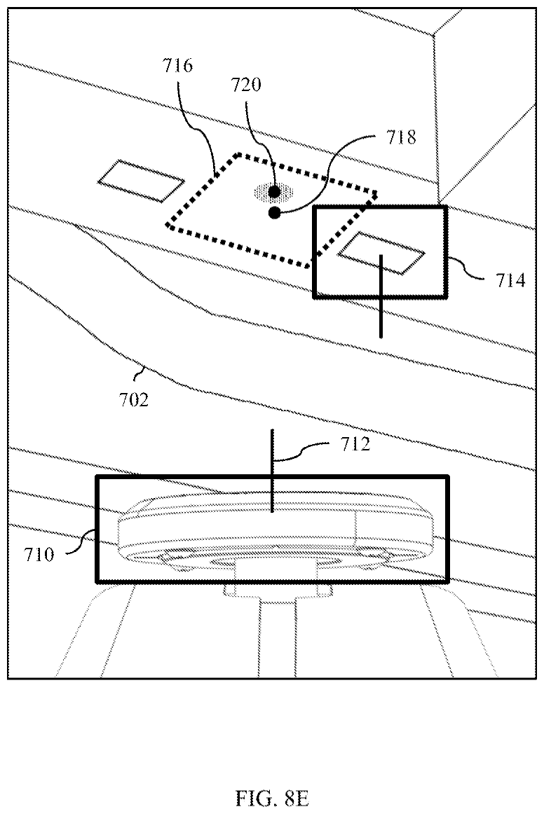

FIG. 7 shows an exemplary set of steps that may be performed when positioning lift arms in a positioning mode. FIGS. 8A-8E show examples of images and interfaces that may be captured and/or displayed as part of the steps performed in FIGS. 3-7. The steps of FIG. 7 describe a staged process for arm positioning that may be performed manually, automatically, or a combination of manually and automatically, and includes stages of pre-positioning, arm rotation, and arm extension. The system may determine (600) a pre-position location based upon information such as one or more of the vehicle identity and/or type (322), the location of the vehicle in the lift area (324), and information known about the vehicle's lift point locations (e.g., whether determined locally or provided by an OEM or another source, as described in the context of FIGS. 4-6). As an example, this may include determining the position of a vehicle lift point within a coordinate system using the vehicle identity (322) and determined location (324), then determining the pre-position location for a particular lift arm within the coordinate system as an offset from the lift point location (e.g., between about 1 inch and about 12 inches, depending upon the capabilities and configuration of a particular lift arm and camera). Determining (600) the pre-position as an offset from the actual lift point by a configured distance increases the likelihood that a camera on the lift arm will be able to capture useful images of the lift point and/or other features of the vehicle when the lift arm is in the pre-position.

One or more lift arms may be rotated and extended (602) from an origin or starting position until the distal end (e.g., typically an adapter) is positioned at the determined (600) pre-position. This movement may be performed manually, automatically, or a combination of manually and automatically, as has been described above in the context of FIGS. 4-6. Once at the pre-position, images (e.g., images taken from a camera along the length of the lift arm) may be captured. FIG. 8A shows an example of an image that may be captured from the pre-position location, and that may be displayed to a user via an interface such as the lift monitor device (310) or lift controller (340). The image in FIG. 8A shows an underside of the vehicle (700) and an adapter (708) of a lift arm positioned at the pre-position point. An approximate location of a lift point (706) is also shown on a structure of the vehicle as proximate to a visible feature (704) of the same structure. Other features of the vehicle not related to the lift point (706) may also be captured within the image, such as an exhaust pipe (702), which is partially visible in FIG. 8A behind the lift point (706) structure.

The system may identify (604) recognizable features within the image using image recognition techniques, as has been described. The locations of identified (604) features may be used for subsequent automated lift operations, for display and visual confirmation to a user of the vehicle lift, or both. FIG. 8B shows an example of an image with several graphical overlays calling out features once they are identified (604). In this example, an adapter box (710) is shown in the image overlaid around the adapter (708), which has been identified by the image recognition process, while a vehicle feature box (714) is shown in the image overlaid around the visible feature (704) of the vehicle, which has also been identified by the image recognition process. A vertical alignment indicator (712) may be added to any overlay to provide an indication of the horizontal center of the identified structure, which may be useful during manual rotation of the arm or during manual confirmation of automatic rotational positioning of the arm.

In some cases, such as shown in FIG. 8A, the ideal lift point (706) may not itself have any visually distinctive features (e.g., it may be a portion of a rail or other structure that runs most of the length of the vehicle). In such cases, where the precise lift point (706) cannot readily be identified (606) using image recognition techniques, the system may instead identify a more visible structure that is proximate to the lift point (706), such as the visible feature (704), and then determine (608) the lift point location within the coordinate system and image using an offset vector specific to each vehicle and lift point. Offset vectors may be received or determined similarly to other vehicle specification information, and they may for example be sourced from an OEM or other third-party specification provider, manually measured and configured, determined from locally available back-calculated historical data for the vehicle, determined from globally available back-calculated historical data for the vehicle, or otherwise determined or selected as will occur to those skilled in the art.

In either case, the system may then overlay (610) alignment and target indicators over features such as the adapter (708), lift point (706), visible feature (704), or other structures as shown in FIG. 8B. FIG. 8C shows another example of such an overlay (610), and includes a target box (716) illustrated as a dotted parallelogram surrounding the area of the lift point (706), which itself is overlaid with a target indicator (718). In some implementations, the target box (716) may be overlaid as a parallelogram or other shape to match the structure of the lift point (706) more closely, as illustrated for example in FIG. 8C. This may be useful as compared to a rectangular or square target box where there are components nearby the lifting point that are unsuitable for lifting the vehicle (e.g., such as the exhaust pipe (702)). A rectangular box overlaid on the lift point (706) may extend beyond the lift point (706) to include some portions of the exhaust pipe (702), which may cause a user or automated process to engage the adapter (708) with the exhaust pipe (702) or another unsuitable lift point and cause damage to the vehicle.

With the target box (716), target indicator (718), and alignment indicator (712) visible and the associated structures identified or determined, the lift arm may be rotated (612) until the alignment indicator (712) is aligned (614) with the target indicator (718). Rotation (612) of the arm may be manual or automated and may also include visual confirmation of alignment (614) by a user viewing an image or interface such as that shown in FIG. 8C, as has been described.

With rotational alignment (614) complete, the system may activate (616) a locator (e.g., the locator (140)) and identify the optical locator that is projected onto the vehicle. The system may also overlay (618) an optical locator indicator onto the identified (616) optical locator, as shown in FIG. 8D. That figure shows an image taken by camera (112) that may be captured, displayed, or both, and that also includes an overlaid locator indicator (720) that is centered upon a projection from the locator (140) (e.g., in this example, a laser focal point projected onto the underside of the vehicle proximate to the target box (716)). [OHO] The system may then begin to extend (620) the lift arm until the locator indicator (720) is within the target box (716) or within a configured threshold distance of the target indicator (718). Once the locator indicator (720) has reached its destination (e.g., within the target box (716) or proximate to the target indicator (718)), lift positioning is complete (624), and subsequent steps may be performed such as operator verification (406), global updates (408), back calculation (410), and other steps shown in FIGS. 3-6. FIG. 8E shows an example of an image after extension (620) of the lift arm and completion (624) of positioning. The projector focal point and overlaid locator indicator (720) are now present within the target box (716). As will be shown and described in more detail below, the locator (140) may be projected from at or near the center of a lift arm adapter, such that raising the lift arm vertically up the column (12) will cause the adapter to engage with the vehicle at the same position of the projected optical locator and locator indicator (720).

While the overlays are illustrated as lines, line boxes, dotted boxes, and solid dots, it should be understood that varying implementations of the system may use any of a variety of visually distinct elements. For example, overlays may use different colors, shapes, styles, or patterns to differentiate between indicators (e.g., the target indicator (718) may be a red dot, while the locator indicator (720) may be a wavy blue rectangle). Overlays may also be dynamic in response to user or system actions, such as movements of the lift arms. For example, in some embodiments the adapter box (710) may change from red to green when the alignment indicator (712) is aligned with the target indicator (718), while in other embodiments the adapter box (710) may change from red to yellow when the alignment indicator (712) is aligned with the target box (716), then change to green when the alignment indicator (712) is aligned with the target indicator (718). In some embodiments, the alignment indicator may extend outward or flash at a gradually increasing frequency as it comes closer to alignment with the target indicator (718), or the locator indicator (720) may flash or change in shape or size when it enters the target box (716). Other examples of visual indicators exist and will be apparent to those of ordinary skill in the art in light of this disclosure.

Some implementations of vehicle lifts configured to perform some or all of the steps described above may include four separate lift arms (e.g., two lift arms on each side). The described positioning modes may be used for each lift arm in sequence or for two or more lift arms in parallel. As an example, in local positioning mode, all four lift arms may automatically pre-position (412) for specific lift points, followed by the user manually moving (404) each of the lift arms to its final position in sequence. As another example, in automatic positioning mode, all four lift arms may automatically pre-position (412) for their corresponding specific lift points, and then may continuously perform position corrections (436) in parallel until alignment is reached for all four lift arms. Thus, in some implementations the lift controller (340) or other device that provides image analyses, feature recognition, and lift arm control may include dedicated components for each lift arm (e.g., four dedicated processors and four dedicated graphical processor units) and may be configured to perform automatic positioning for each lift arm in parallel and in isolation with such dedicated components.

### III. Exemplary Vehicle Lift Arms

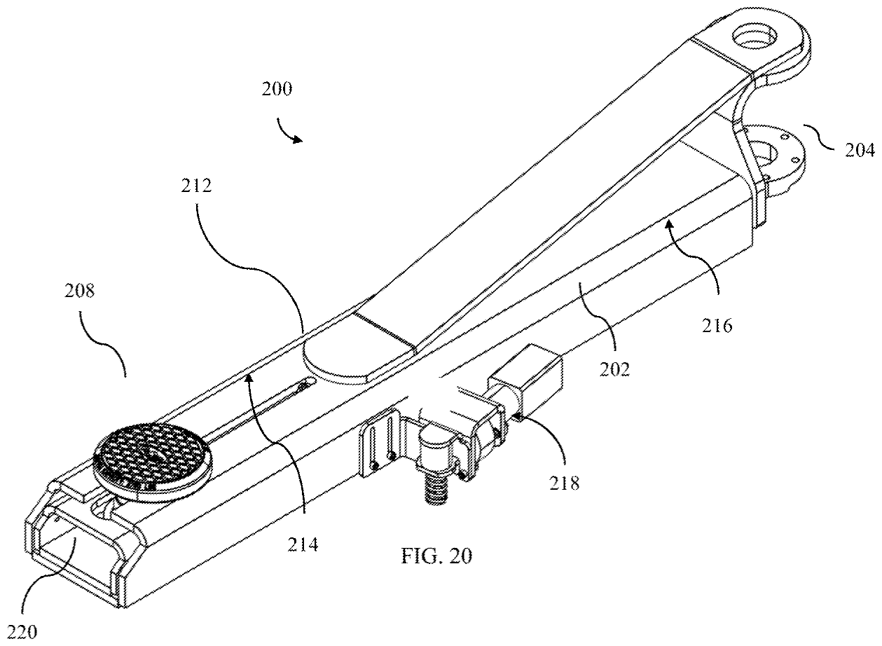

Implementations of the above-described positioning modes may utilize cameras that provide images, locators that provide visual indications of the adapter position, or both. In order to provide images with a usable field of view, lift arms may be specifically designed to allow for the adapter and camera to be offset from each other while maintaining a static relative positioning. FIGS. 9 through 25 show examples of vehicle lift arms that may support such a camera configuration, as well as centrally positioned locator within the adapter. FIG. 9 shows a perspective view of an exemplary short arm (100), while FIG. 20 shows a perspective view of an exemplary long arm (200). A vehicle lift post such as the lift post (10) shown in FIG. 1 often includes a short arm and a long arm to allow vehicles to be positioned relative to the lift posts, depending upon such factors as their overall dimensions and center of gravity.

The short arm (100) includes an inner arm (120) that may be extended from and retracted into an outer arm (102). A rotation coupling (104) allows the short arm (100) to be rotatably coupled to a lift post. In some implementations, a motor or other mechanism of the lift post may rotate the short arm (100) via the rotation coupling (104). The short arm (100) is also shown to include a drive assembly (118) that includes a motor-driven wheel that is operable to rotate the short arm (100) around the rotation coupling (104). A support member (106) spans from the top of the rotation coupling (104) to a mid-point along the outer arm (102) to reduce the strain on the pin (not pictured) or other portion of the lift post that passes through the rotation coupling (104) to couple the short arm (100) to the lift post.

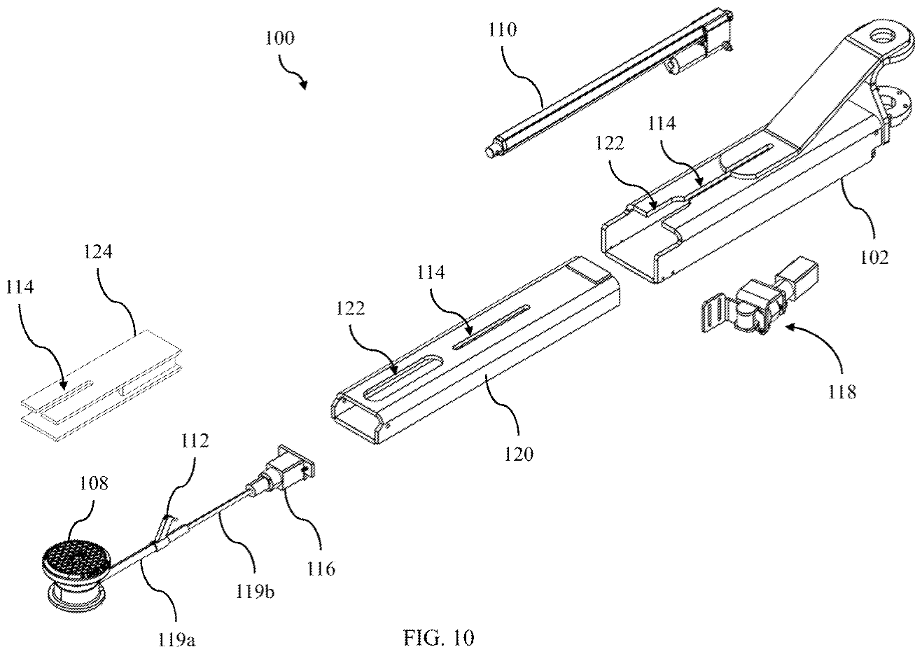

An adapter (108) is shown at a distal end of the short arm (100). An inner arm actuator (110) is shown coupling the outer arm (102) to the inner arm (120) and is operable to extend and retract the inner arm (120). A portion of the camera (112) can be seen positioned within a slot (114) that runs along a partial length of the inner arm (120), outer arm (102), and support member (106), which allows the camera (112) to slide along the slot (114) during repositioning of the lift arm, as will be shown and described in more detail below. The short arm (100) also includes an adapter actuator (116), which is obstructed from view in FIG. 9, but is shown in FIG. 10 and elsewhere. The adapter actuator (116) is operable to extend and retract the adapter (108) within the short inner arm (120) and allows repositioning of the adapter independently of the inner arm actuator (110).

FIG. 10 shows an exploded view of the short arm (100) of FIG. 9. With the inner arm (120) removed from the outer arm (102), separate portions of the slot (114) can be seen in each component. An actuator case (124) is also shown removed from the inner arm (120), and also defines a portion of the slot (114). When assembled, the actuator case (124) is statically positioned in a proximal end of the inner arm (120), and the adapter actuator (116) is assembled therein. The inner arm (120) and outer arm (102) are also shown to define an adapter slot (122), in which the adapter (108) is slidably positioned. During operation of the adapter actuator (116), the adapter (108) may be extended and retracted within the confines of the adapter slot (122).

The camera (112) can be seen more clearly in FIG. 10, extending upwards from a rod portion (119a), which can be linearly extended and retracted from a statically positioned rod portion (119b) during operation of the adapter actuator (116). This causes the adapter (108), which is statically coupled to the distal end of the rod portion (119a), to correspondingly extend and retract. As can be seen, the camera (112) extends from the rod portion (119a) and is statically positioned relative to both that rod portion (119a) and the adapter (108). The camera (112) may be coupled to the rod portion (119a) using a riser or angled holder in order to achieve the desired offset and orientation for the camera (112) relative to the adapter (108). This offset and orientation may vary by implementation, but they will typically be selected based on the capabilities of the camera (112) and the desired field of view to be provided for the images (e.g., as described in the context of displaying (402) and capturing (408) images in at least FIGS. 4-8).

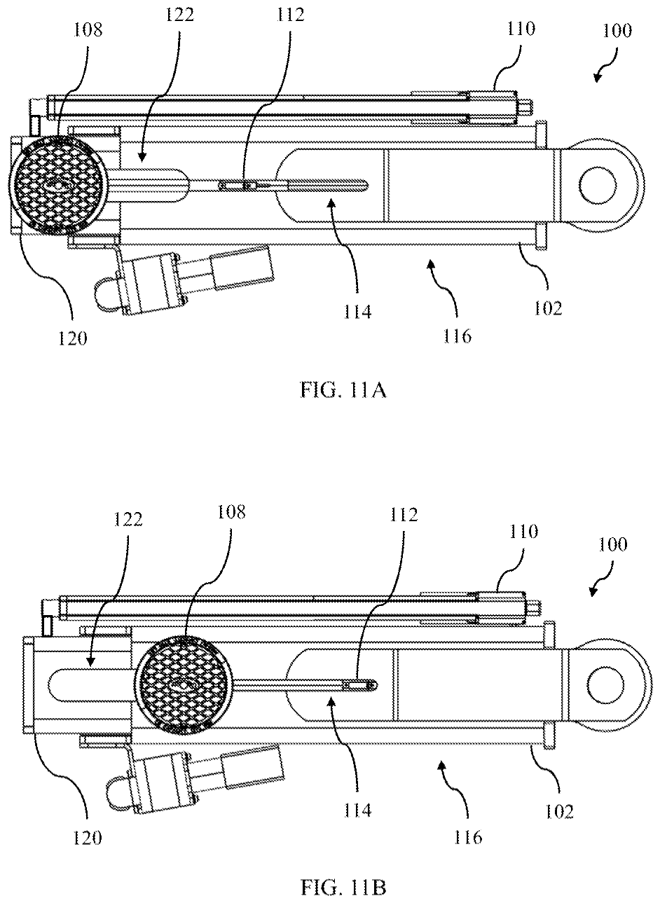

FIG. 11A shows a top-down view of the short arm (100) of FIG. 9 with the adapter (108) extended to a first position within the adapter slot (122). At the first position, the adapter (108) has been extended to the distal end of the adapter slot (122) by operation of the adapter actuator (116). The camera (112) is itself positioned within the slot (114) at a position that corresponds to the first position of the adapter (108), since the camera (112) and the adapter (108) are statically positioned relative to each other. FIG. 11B shows a top-down view of the short arm (100) of FIG. 9 with the adapter retracted to a second position within the adapter slot (122). At the second position, the adapter (108) has been retracted to the proximal end of the adapter slot (122) by operation of the adapter actuator (116). The camera (112) can be seen positioned within the slot (114) at a position that corresponds to the second position of the adapter (108), due to the static relative positioning of the camera (112) and the adapter (108). As can be seen, the lengths of the slot (114), the adapter slot (122), and the rod portions (119a, 119b), as well as the operational characteristics of the adapter actuator (116), are all correlated to allow the adapter (108) to be extended and retracted without the adapter (108) itself or the camera (112) being obstructed by other portions of the short arm (100). As an example, where the adapter slot (122) is twelve inches long, the slot (114) portions may also be twelve inches long, and the adapter actuator (116) and rod portions (119a, 119b) may also be configured to allow for twelve inches of linear extension and retraction. In this manner, the short arm (100) allows for a twelve-inch range in which the adapter (108) may be repositioned independently of operation of the inner arm actuator (110).

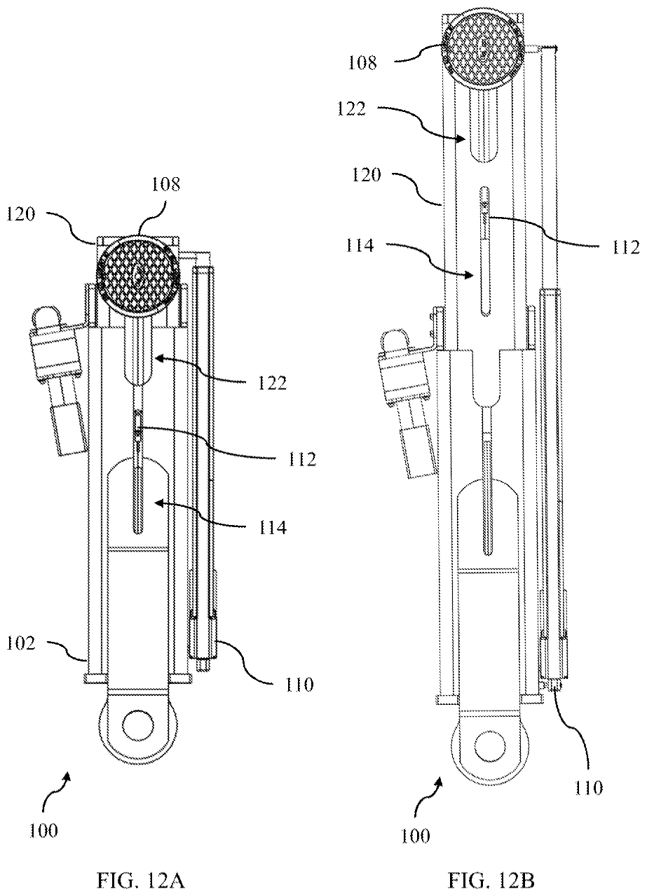

FIG. 12A shows a top-down view of the short arm (100) of FIG. 9 with the inner arm (120) retracted to a first position. As depicted in FIG. 12A, the adapter (108) is positioned at the distal end of the adapter slot (122) but may be positioned anywhere within the adapter slot (122) independently of the position of the inner arm (120). At the first position, the inner arm actuator (110) has been fully retracted. FIG. 12B shows a top-down view of the short arm (100) of FIG. 9 with the inner arm (120) extended to a second position. As in FIG. 12A, the adapter (108) is positioned at the distal end of the adapter slot (122) but may be positioned anywhere within the adapter slot (122) independently of the position of the inner arm (120). At the second position, the inner arm actuator (110) has been fully extended, causing the inner arm (120) to fully extend from the outer arm (102).

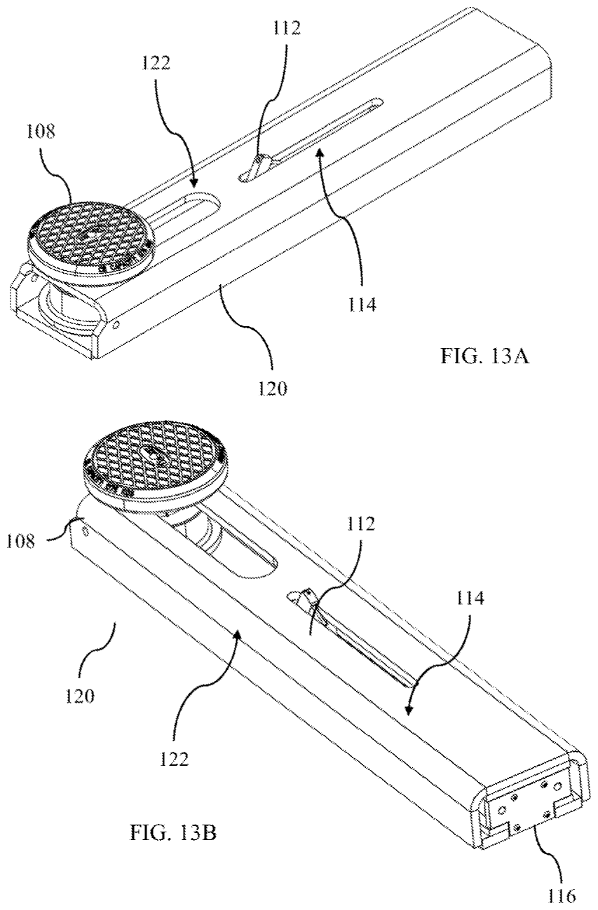

FIG. 13A shows a front perspective view of the inner arm (120), isolated from the outer arm (102). The camera (112) can be seen extending upwards through the slot (114) and positioned at a desired angle to provide the images usable in the above-described positioning modes. FIG. 13B shows a rear perspective view of the inner arm (120) of FIG. 13A, from which the rear of the adapter actuator (116) can be seen positioned within the actuator case (124). The actuator case (124) and the adapter actuator (116) are statically coupled to the inner arm (120) at this position, such that operation of the adapter actuator (116) causes the adapter (108) to extend and retract within the inner arm (120).

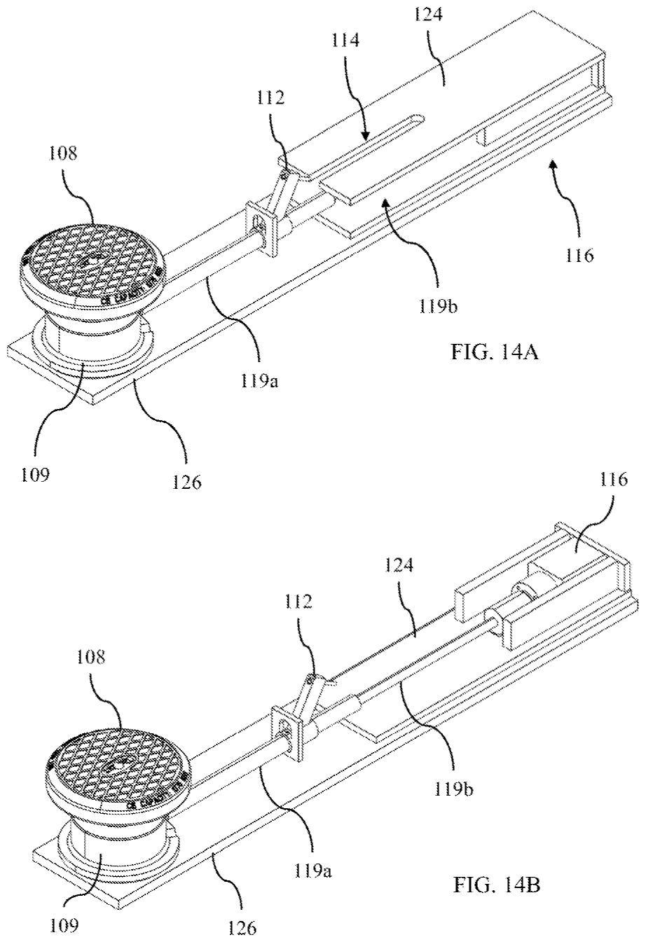

FIG. 14A shows a perspective view of the inner arm (120) of FIG. 13A with portions of a housing removed to show an interior of the inner arm (120). The actuator case (124) is visible, fixed within the inner arm (120), with the rod portions (119a, 119b) extending from within. The relative positions of the slot (114) of the actuator case (124) and the camera (112) are also depicted. A bottom plate (126) of the inner arm (120) is also shown, along which a puck (109) that holds the adapter (108) slides as it is extended and retracted by operation of the adapter actuator (116). The adapter (108) is typically not bearing any weight during repositioning by the adapter actuator (116), so the bottom plate (126) may provide a suitably smooth surface on which the puck (109) may readily slide with regular cleaning and treatment with machine grease or other lubricants to allow for smooth operation. FIG. 14B shows a perspective view of the inner arm (120) with additional portions of a housing removed to further illustrate the installation of the adapter actuator (116) within the inner arm (120). FIG. 15A shows a bottom perspective view of the actuator case (124), where a cutout (128) for the adapter actuator (116) is visible, while FIG. 15B shows the actuator assembly (e.g., the adapter actuator (116) and rod portions (119a, 119b)) isolated from the inner arm (120).

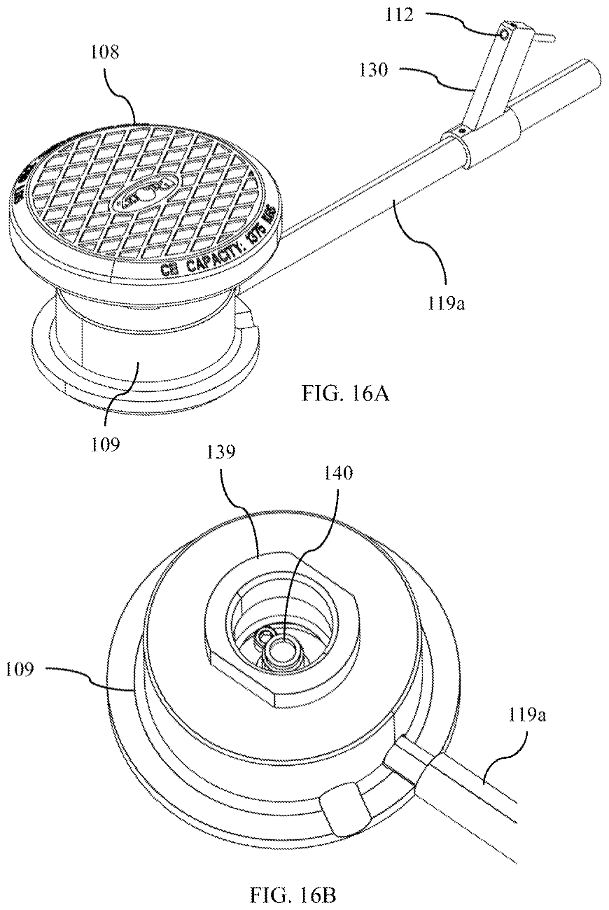

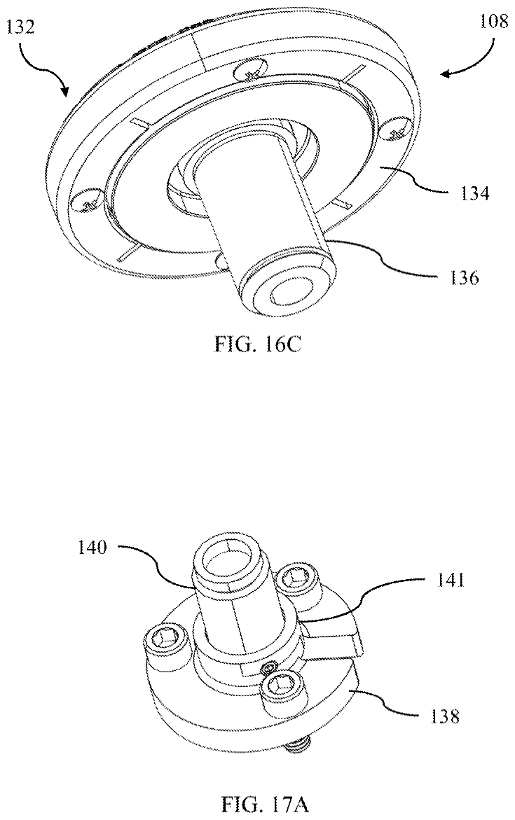

FIG. 16A shows the adapter (108) held by the puck (109), which itself is coupled to the distal end of the rod portion (119a). The camera (112) is shown installed within a camera mount (130). The camera mount (130) is coupled to the rod portion (119a) and provides an angled extension to position the camera (112) at an offset and varied angle relative to the rod portion (119a). In some implementations, the camera mount (130) may position the camera (112) so that it is parallel to the rod portion (119a). In some implementations, the camera mount (130) may position the camera at any desired offset from the rod portion (119a), and at any desired angle relative to the rod portion (119a), as may be desired based on the particular capabilities of the camera (112) and the desired field of view for the images. In some implementations, the camera mount (130) may be statically shaped and sized, while in other implementations the camera mount (130) may allow for adjustable offset of the camera (112) or an adjustable angle of the camera (112). In some implementations with an adjustable camera mount (130), the camera mount may be automatically and electronically adjustable based on control signals in order to vary its offset or angle at various stages of vehicle lifting, or for varying types of vehicles.

FIG. 16B shows the distal end of the rod portion (119a) and the puck (109) with the adapter (108) removed from an adapter receiver (139) defined by an opening on the face of the puck (109). The adapter receiver (139) is configured to receive a stem (e.g., the stem (136) shown in FIG. 17A) of the adapter (108) and support the adapter (108) and any load it carries without damage to a locator (140) that is positioned within a hollow of the puck (109). FIG. 16C shows the adapter (108) removed from the puck (109). The adapter (108) includes a top plate (132), a bottom plate (134), and the stem (136). The adapter (108) may be inserted and removed from the puck (109) and may be replaced by other interchangeable adapters that may have varying shapes, designs, and styles of top plate (132) that are specialized for different lift points of a vehicle.

As illustrated in FIGS. 17A-17C, the adapter (108) and puck (109) are configured to provide an unobstructed optical path along which the locator (140) may project an optical locator. FIG. 17A shows the locator (140), which may be, for example, a laser operable to produce a laser beam focal spot, a light projector operable to produce another type of light (e.g., infrared), or a projector operable to produce a barcode, QR code, or other light grid or light pattern as may be desired. The locator (140) is coupled to a coupling (138) that fits within the puck (109) and positions the locator (140) along the unobstructed optical path.

Positioned within the puck (109), the locator (140) may maintain an unobstructed optical axis through the adapter (108) while remaining protected from damage or contaminants during use. The unobstructed optical axis is illustrated in FIG. 17B, which shows an exploded view of the adapter (108) and locator (140). An optical axis (144) is illustrated as a dotted line beginning at the locator (140). The stem (136) includes a hollow interior channel that is capped by a lens (142) aligned with the optical axis (144), allowing a projection from the locator (140) to pass through. When fully assembled, the lens (142) may pass into an aperture at the center of the bottom plate (134) and may be flush with or just below an aperture at the center of the top plate (132). The lens (142) may be replaceable and may be made from a reinforced glass (e.g., GORILLA glass) or plastic that allows high transmission of light along the optical axis (144) while preventing mechanical impingement and contamination by debris of the interior of the locator case (136). The optical axis (144) is further illustrated in FIG. 17C, which shows a side cross-sectional view of the adapter (108) and the puck (109). The optical axis (144) can be seen illustrated as a dotted line that runs unobstructed from the locator (140), through an interior channel of the stem (136), through the lens (142), and through apertures defined by both the bottom plate (134) and the top plate (132). The stem (136) can also be seen fitted within the adapter receiver (139) and with a distal end supported by a lip (141) of the coupling (138), such that the locator (140) itself does not bear any load from the adapter (108) or the vehicle during a lifting operation.

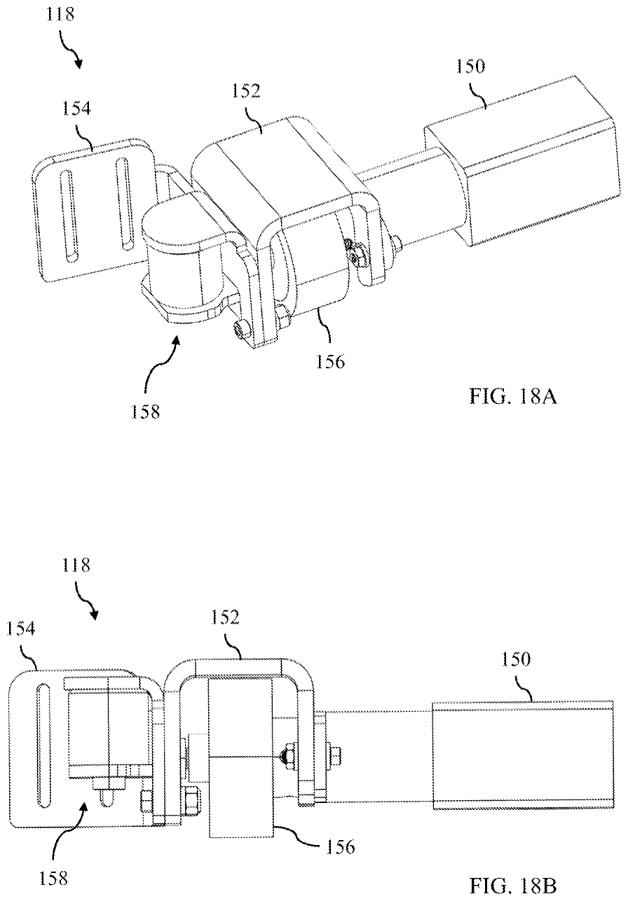

FIG. 18A shows a perspective view of the drive assembly (118). The drive assembly (118) includes a motor (150) that is coupled to a wheel (156) and is operable to rotate the wheel (156) in either direction with a varying amount of force. The wheel (156) is housed within a wheel case (152), which is coupled to a drive mount (154) by a suspension coupling (158) that allows the wheel case (152) and the drive mount (154) to slidably displace relative to each other, along at least one axis, in response to a force on either. The drive mount (154) may include slots or holes by which it may be coupled to the short arm (100) (for example, or, in some implementations, the long arm (200)). The drive mount (154) may be vertically adjusted upon installation on the short arm (100) so that the wheel (156) contacts the ground when one of the lift arms (14, 16) is lowered and positioned above the highest (e.g., most proximal) point of a ground surface upon which the lift is installed. The suspension coupling (158) is configured to flexibly bias the wheel case (152), wheel (156), and motor (150) to maintain contact with the ground surface as the short arm (100) is rotated to positions where the lift arm is over a portion of the ground surface that is lower than the highest point (e.g., more distant from the wheel (156) than the most proximal point of the ground surface at which the drive mount (154) is initially installed). FIG. 18B shows a side elevation view of the drive assembly of FIG. 18A, where the wheel (156) can be seen clearly housed within the wheel case (152) and coupled to the motor (150).

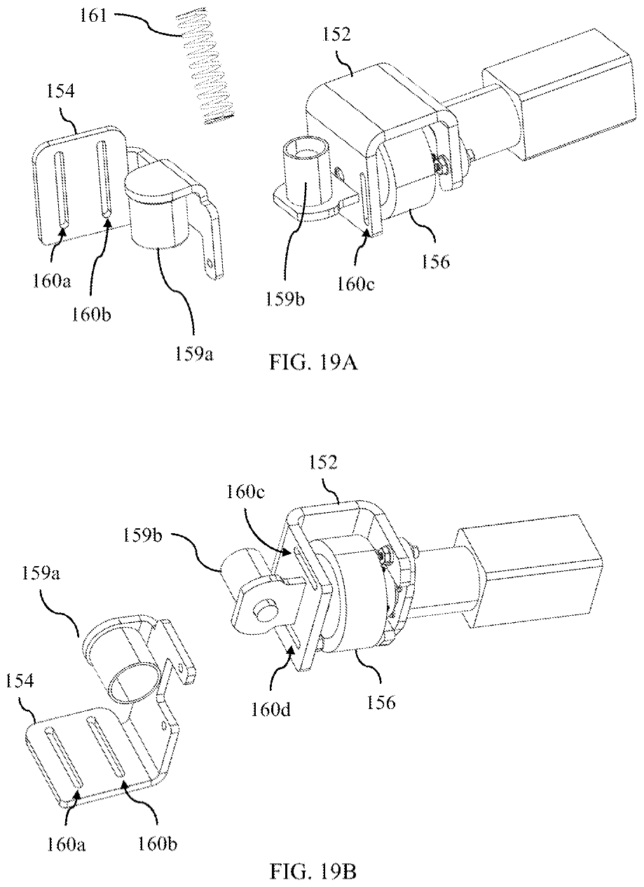

FIGS. 19A and 19B show perspective views of the drive assembly of FIG. 18A partially disassembled. The drive mount (154) is shown decoupled from the wheel case (152), and the suspension coupling (158) is disassembled to show a pair of suspension cylinders (159a, 159b) that are hollow and sized to nest together, and a spring (161) that is contained by the cylinders (159a, 159b) to provide a spring force bias that allows the wheel (156) to maintain contact with a ground surface during rotation of the short arm (100). In some implementations, biasing force could be provided by pneumatics, hydraulics, electrical actuation, or other biasing means in place of a spring. The drive mount (154) includes a pair of slots (160a, 160b) by which the drive mount (154) may be coupled to the short arm (100), and the wheel case (152) includes a pair of slots (160c, 160d) by which the wheel case (152) may be slidably coupled to the drive mount (154) so that it slides up or down as the suspension coupling (158) compresses or expands.

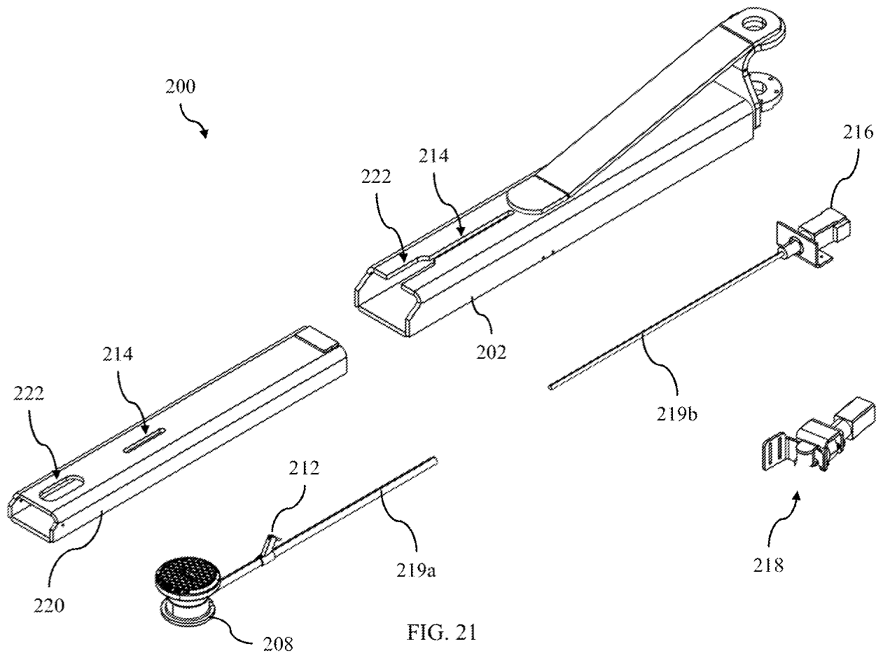

FIG. 20 shows a long arm (200) that may be used with a lift post such as the lift post (10) shown in FIG. 1. The long arm (200) may be used in a pair with the short arm (100), and each may be used in the positioning modes described above. The long arm (200) includes an inner arm (220) that is slidably contained within an outer arm (202). A rotation coupling (204) may receive a pin or other structure to rotatably couple the long arm (200) to a lift post. An adapter (208) is positioned at a distal end of the inner arm (220), and a camera (212) can be seen positioned within a slot (214) that runs along a portion of the outer arm (202) and inner arm (220). An adapter actuator (216) is contained within the outer arm (202) and coupled to the adapter (208). During operation, the adapter actuator (216) may extend or retract the adapter (208) and, when the adapter (208) reaches the limits of an adapter slot (222) (e.g., as shown in FIG. 21), may also extend or retract the inner arm (220). A drive assembly (218) is coupled to the outer arm (202) and operable to rotate the long arm (200) in either direction. The drive assembly (218) is substantially similar to the drive assembly (118), shown and discussed in FIGS. 18A-19B.

FIG. 21 shows an exploded view of the long arm (200) of FIG. 20. Each of the outer arm (202) and inner arm (220) include portions of the slot (214), which are sized and positioned to allow the camera (212) to slide therein unobstructed during extension and retraction of the adapter (208), and also include portions of the adapter slot (222), which are sized and positioned to allow the adapter (208) to slide therein during operation of the adapter actuator (216). In this embodiment, the adapter actuator (216) includes a rod portion (219b) and a rod portion (219a) that may be coupled together. During operation of the adapter actuator (216), the distal rod portion (219a) may be extended and retracted. The camera (212) can be seen coupled to and extending from the distal rod portion (219a) such that images may be captured by the camera (212) and used in the positioning modes described above.

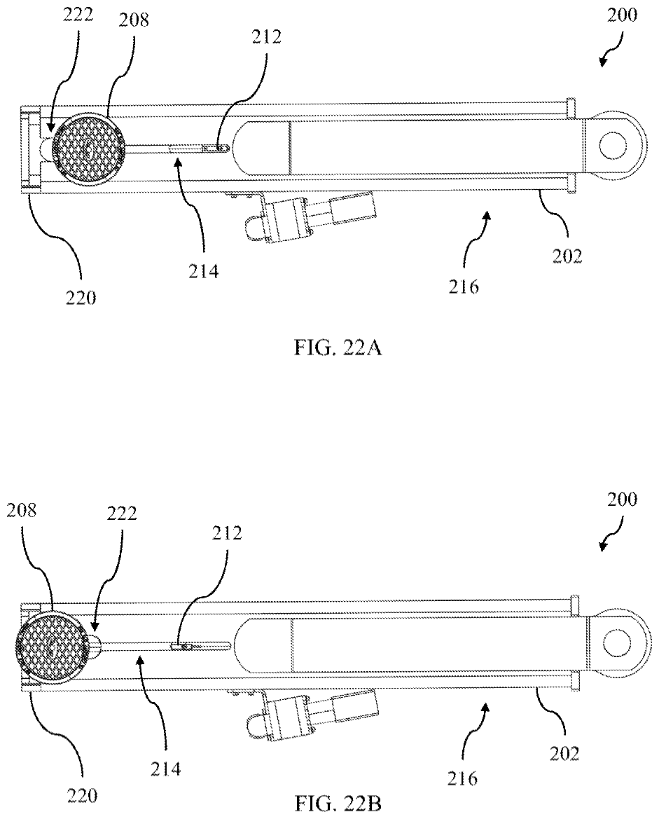

FIG. 22A shows the long arm (200) with the adapter (208) retracted to a first position within the adapter slot (222), while FIG. 22B shows the long arm (200) with the adapter extended to a second position within the adapter slot (222). As with prior examples, the camera (212) can be seen to have a corresponding position within the slot (114) for each position of the adapter (208), such that each may move in static relation to each other during operation of the adapter actuator (216).

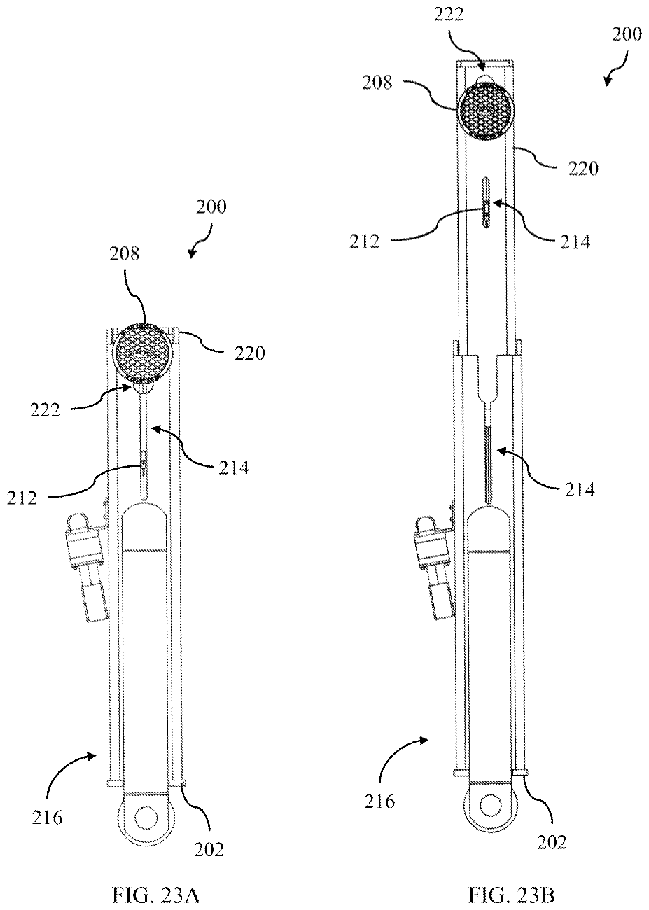

FIG. 23A shows the long arm (200) with the inner arm (220) retracted to a first position. From the position shown in FIG. 23A, the adapter (208) can be seen to be at the distal limit of the adapter slot (222). At this position, actuation of the adapter (208) will continue to linearly push the adapter (208) against the distal limit of the adapter slot (222) and thereby cause the inner arm (220) to begin to slidably extend from the outer arm (202). FIG. 23B shows the long arm (200) with the inner arm (220) extended to a second position, approximate to the maximum extension of the inner arm (220) from the outer arm (202). Upon reaching a maximum extension of the inner arm (220), the adapter (208) will initially be positioned at the distal limit of the adapter slot (222) (e.g., as shown in FIG. 23A). Operation of the adapter actuator (216) to retract the adapter (208) will first cause it to slide along the adapter slot (222) until the proximal limit of the adapter slot (222) is reached. Additional retraction by the adapter actuator (216) will pull the adapter (208) against the proximal limit of the adapter slot (222) and cause the inner arm (220) to retract into the outer arm (202).

FIG. 24A shows the long arm (200) with portions of a housing removed to show the inner arm (220). A bottom plate (226) of the outer arm (202) can be seen, with the inner arm (220) slidably resting thereon. As with previous examples, the bottom plate (226) may include a smooth and/or lubricated surface to allow for ease of operation during extension and retraction of the inner arm (220). An actuator mount (228) is coupled to the bottom plate (226), with the adapter actuator (216) mounted thereon. FIG. 24B shows the long arm (200) with additional portions of a housing removed, such that a bottom plate (227) of the inner arm (220) is visible resting on the bottom plate (226) of the outer arm (202). The adapter (208) can be seen slidably resting on the bottom plate (227) of the inner arm (220), and the rod portions (219a, 219b) can be seen extending from the adapter actuator (216) to the adapter (208). As with prior examples, the camera (212) is coupled to the distal rod portion (219a) via a camera mount (230) that may provide a static offset position and orientation relative to the adapter (208) so that images may be captured in the above-described positioning modes.

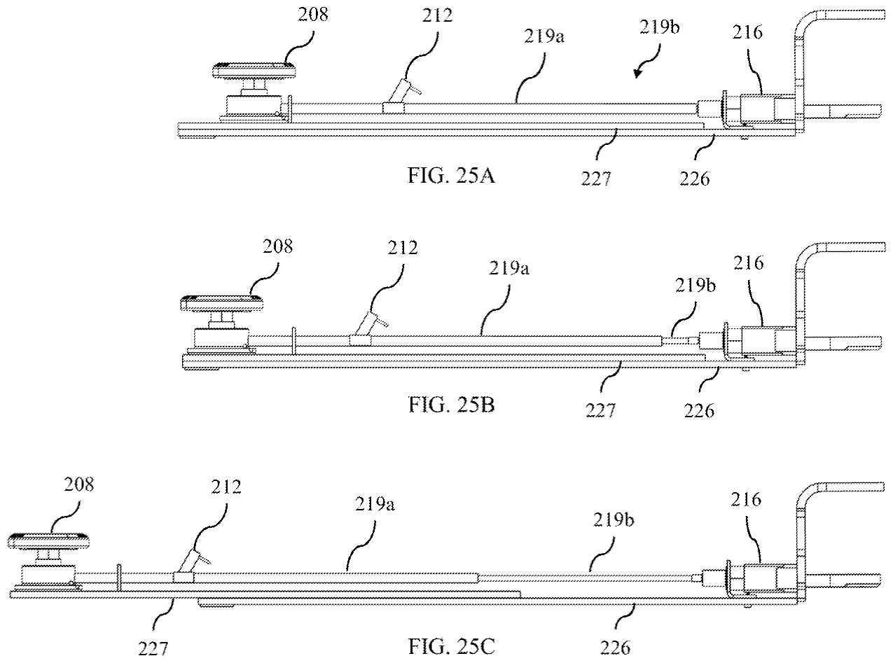

FIGS. 25A-25C show the long arm (200), as depicted in FIG. 24B at several stages during extension of the adapter (208). In FIG. 25A, the adapter (208) is retracted to a position approximate to the proximal limit of the adapter slot (222), while the bottom plate (227) of the inner arm (220) is also retracted to its proximal limit. Operation of the adapter actuator (216) to extend the adapter (208) from the position of FIG. 25A will cause the adapter (208) to extend within the adapter slot (222) until its distal limit is reached at the approximate position shown in FIG. 25B. In that figure, the adapter (208) is seen to be slightly extended as compared to FIG. 25A, and the rod portion (219b) is now visible as the rod portion (219a) is extended. It can further be seen that the bottom plate (227) of the inner arm (220) has not moved or extended, and the relative positions of the camera (212) and adapter (208) also have not changed. As the adapter actuator (216) continues to extend, the adapter (208) will push against the distal limit of the adapter slot (222) and begin to extend the inner arm (220), as shown in FIG. 25C. In that figure it can be seen that additional lengths of the rod portion (219b) are visible as it continues to extend, and that the bottom plate (227) of the inner arm (220) has begun to extend due to the force being applied to the distal limit of the adapter slot (222). Retraction of the adapter (208) from the position shown in FIG. 25C will result in the adapter (208) first retracting to the proximal limit of the adapter slot (222), and then the inner arm (220) and bottom plate (227) retracting to their origin position.

### IV. Exemplary Combinations

A first exemplary embodiment is a system for vehicle lift positioning comprising (a) one or more lift posts; (b) a set of lift arms coupled to the one or more lift posts, wherein each lift arm of the set of lift arms comprises (i) an adapter, wherein the lift arm is operable to rotate and extend using a powered mechanism to engage a lift point of a vehicle, (ii) a locator configured to project an optical locator onto an area of the vehicle above the adapter, and (iii) a camera, wherein the camera is configured to capture an image, wherein the image includes the lift point and the optical locator, and wherein the camera and the adapter are spaced apart; and (c) one or more processors configured to, for each lift arm of the set of lift arms (i) move the lift arm to a pre-position of the lift arm relative to the vehicle, (ii) capture one or more images from the camera, (iii) move the lift arm from the pre-position to a final position relative to the vehicle, wherein the final position is determined based on the one or more images, and (iv) upon reaching the final position, raise the lift arm to engage the adapter with a corresponding lift point and lift the vehicle.

A second exemplary embodiment is a variation of the first exemplary embodiment, wherein the one or more processors are further configured to: (i) receive a set of lift area data from a set of lift sensors; and (ii) determine a position of the vehicle relative to the one or more lift posts based on the set of lift area data; and wherein the pre-position of at least one lift arm of the set of lift arms is determined as a function of the position of the vehicle.

A third exemplary embodiment is a variation of the second exemplary embodiment, wherein the one or more processors, in a manual positioning mode, are further configured to, for each lift arm of the set of lift arms: (i) move that lift arm to the pre-position based on a first set of user inputs; (ii) move that lift arm to the final position based on a second set of user inputs; (iii) back-calculate a back-calculated position of the corresponding lift point based on the position of the vehicle, the first set of user inputs, and the second set of user inputs; and (iv) save and associate the back-calculated position of the corresponding lift point with the vehicle.

A fourth exemplary embodiment is a variation of the third exemplary embodiment, wherein the one or more processors are further configured to, during a subsequent use with the vehicle and for each lift arm of the set of lift arms: (i) identify the previously saved, back-calculated position of the corresponding lift point; and (ii) automatically move that lift arm based on the previously saved, back-calculated position of the corresponding lift point.

A fifth exemplary embodiment is a variation of the second exemplary embodiment, wherein the one or more processors, in a local positioning mode, are further configured to, for each lift arm of the set of lift arms, automatically move that lift arm to the pre-position based on: (i) the position of the vehicle relative to the one or more lift posts, and (ii) a back-calculated position of the corresponding lift point, where the back-calculated position is determined based on an identification of the vehicle.

A sixth exemplary embodiment is a variation of the second exemplary embodiment, wherein the one or more processors, in an OEM positioning mode, are further configured to, for each lift arm of the set of lift arms, automatically move that lift arm to the pre-position based on: (i) the position of the vehicle relative to the one or more lift posts, and (ii) a position of the corresponding lift point that is selected from a lift point dataset provided by a manufacturer of the vehicle based on an identification of the vehicle.

A seventh exemplary embodiment is a variation of the second exemplary embodiment, wherein the one or more processors, in an automatic positioning mode, are further configured to receive an identity of the vehicle and, for each lift arm of the set of lift arms: (i) automatically move that lift arm to the pre-position based on the position of the vehicle relative to the one or more lift posts and a position of the corresponding lift point, where the corresponding lift point is determined based on the identity of the vehicle; (ii) perform an object recognition process on the one or more images to identify a location of the corresponding lift point within the one or more images; (iii) determine a spatial relationship between the corresponding lift point and the adapter based on the location identified; and (iv) automatically move that lift arm toward the final position based on the spatial relationship between the corresponding lift point and the adapter.

An eighth exemplary embodiment is a variation of the seventh exemplary embodiment, wherein the one or more processors are further configured to: (i) perform the object recognition process on the one or more images to identify a location of the optical locator projected onto the area of the vehicle within the one or more images, and (ii) after automatically moving that lift arm toward the final position based on the spatial relationship, determine whether the location of the optical locator is aligned with the location of the corresponding lift point.

A ninth exemplary embodiment is a variation of the eighth exemplary embodiment, wherein the one or more processors are further configured to, where the location of the optical locator is not aligned with the location of the corresponding lift point, (i) redetermine the spatial relationship based on the location of the optical locator and the location of the corresponding lift point, and (ii) automatically move that lift arm toward the final position based on the redetermined spatial relationship.

A tenth exemplary embodiment is a variation of the seventh exemplary embodiment, wherein (a) each lift arm of the set of lift arms is associated with a dedicated processor of the one or more processors; and (b) each dedicated processor is configured to perform the object recognition process for its associated lift arm in parallel with the other dedicated processors.

An eleventh exemplary embodiment is a variation of the first exemplary embodiment, wherein each lift arm of the set of lift arms comprises (a) an extendable member that is operable to horizontally extend and retract the adapter; and (b) the camera is coupled to the extendable member and provides a static field of view relative to the adapter during extension and retraction of the adapter.

A twelfth exemplary embodiment is a variation of the eleventh exemplary embodiment, wherein (a) each lift arm of the set of lift arms defines a longitudinal slot, and (b) the camera is positioned to slide within the longitudinal slot during extension and retraction of the adapter.

A thirteenth exemplary embodiment is a variation of the twelfth exemplary embodiment, wherein the adapter of each lift arm comprises: (a) an unobstructed optical axis from inside the adapter through a top plate of the adapter, and (b) the locator positioned inside the adapter and operable to project the optical locator along the unobstructed optical axis onto a surface above the adapter.

A fourteenth exemplary embodiment is a variation of the first exemplary embodiment, wherein the one or more processors are further configured to lower the lift arm and vehicle to disengage the adapter with the corresponding lift point.

A fifteenth exemplary embodiment is a variation of the fourteenth exemplary embodiment, wherein the one or more processors are further configured to: (a) move the lift arm from the final position to the pre-position, and (b) upon reaching the pre-position, move the lift arm to an initial position so that the vehicle can exit a lift area without contacting the lift arm.

A sixteenth exemplary embodiment is a system for vehicle lift positioning comprising (a) a lift post; (b) a lift arm coupled to the lift post, wherein the lift arm comprises (i) an adapter, wherein the lift arm is operable to rotate and extend the adapter using a powered mechanism to engage a lift point of a vehicle, and (ii) a drive assembly, wherein the drive assembly comprises (A) a wheel, (B) a motor operable to drive the wheel in either direction to selectively move the lift arm along a ground surface, and (C) a suspension coupling configured to flexibly bias the wheel toward the ground surface during operation; and (c) one or more processors configured to (i) use the wheel to move the lift arm to a position, and (ii) upon the lift arm reaching the position, raise the lift arm to engage the adapter with the lift point of the vehicle.

A seventeenth exemplary embodiment is a variation of the sixteenth exemplary embodiment, wherein the lift arm comprises an inner arm and an outer arm, and further comprising an inner arm actuator operable to extend or retract the inner arm from the outer arm, wherein the inner arm actuator has a static portion.

An eighteenth exemplary embodiment is a variation of the seventeenth exemplary embodiment, wherein the inner arm actuator is positioned within the inner arm, and the static portion is coupled to the inner arm.

A nineteenth exemplary embodiment is a variation of the seventeenth exemplary embodiment, wherein the inner arm and outer arm define an adapter slot, the adapter is slidably positioned in the adapter slot, and the inner arm actuator is operable to (a) extend the adapter to a distal limit of the adapter slot; (b) after said extending, continue to extend the adapter against the distal limit of the adapter slot, thereby extending the inner arm from the outer arm; (c) retract the adapter to a proximal limit of the adapter slot; and (d) after said retracting, continue to retract the adapter against the proximal limit of the adapter slot, thereby retracting the inner arm into the outer arm.

A twentieth exemplary embodiment is a method for vehicle lift positioning, comprising (a) using one or more processors, receiving an identification of a vehicle in a lift area; (b) determining a location of the vehicle within the lift area based on a set of lift area data from a set of lift sensors; (c) determining positions of a set of lift points for the vehicle based on the identification and the location of the vehicle; and (d) for at least one lift arm of a set of lift arms (i) matching that lift arm with one of the lift points in the set of lift points; (ii) operating one or more motors to move that lift arm to a pre-position relative to the vehicle based on a position of a corresponding lift point of the set of lift points, wherein the pre-position is offset from the position of the corresponding lift point by a configured arm extension distance; (iii) capturing one or more images of the vehicle; (iv) performing a feature recognition process on the one or more images to identify a location of the corresponding lift point within the one or more images, wherein the location of the corresponding lift point is determined directly or as a function of a configured offset from another identified feature of the vehicle within the one or more images; (iv) displaying an alignment indicator; (v) overlaying a target box on the corresponding lift point based on the feature recognition process; (vi) operating the one or more motors to rotate that lift arm until the alignment indicator is aligned with the lift point; (vii) identifying in the one or more images an optical locator projected onto the vehicle and overlaying a locator indicator onto the optical locator; and (viii) operating the one or more motors to extend the lift arm until the locator indicator is within the target box.

A twenty first exemplary embodiment is a variation of the nineteenth exemplary embodiment, wherein the static portion of the inner arm actuator is coupled to the outer arm.

In this description and the claims, “based on” should be understood to mean that something is determined at least in part by the thing that it is indicated as being “based on.” When something is completely determined by a thing, it will be characterized as being “based exclusively on” the thing.

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

1. A system for vehicle lift positioning comprising:
(a) one or more lift posts;
(b) a set of lift arms coupled to the one or more lift posts, wherein each lift arm of the set of lift arms comprises:
(i) an adapter, wherein the lift arm is operable to rotate and extend using a powered mechanism to engage a lift point of a vehicle,
(ii) a locator configured to project an optical locator onto an area of the vehicle above the adapter, and
(iii) a camera, wherein the camera is configured to capture an image, wherein the image includes the lift point and the optical locator, and wherein the camera and the adapter are spaced apart; and
(c) one or more processors configured to, for each lift arm of the set of lift arms:
(i) move the lift arm to a pre-position of the lift arm relative to the vehicle,
(ii) capture one or more images from the camera,
(iii) move the lift arm from the pre-position to a final position relative to the vehicle, wherein the final position is determined based on the one or more images, and
(iv) upon reaching the final position, raise the lift arm to engage the adapter with a corresponding lift point and lift the vehicle.

2. The system of claim 1, wherein the one or more processors are further configured to:
(i) receive a set of lift area data from a set of lift sensors; and
(ii) determine a position of the vehicle relative to the one or more lift posts based on the set of lift area data; and
wherein the pre-position of at least one lift arm of the set of lift arms is determined as a function of the position of the vehicle.

3. The system of claim 2, wherein the one or more processors, in a manual positioning mode, are further configured to, for each lift arm of the set of lift arms:
(i) move that lift arm to the pre-position based on a first set of user inputs;
(ii) move that lift arm to the final position based on a second set of user inputs;
(iii) back-calculate a back-calculated position of the corresponding lift point based on the position of the vehicle, the first set of user inputs, and the second set of user inputs; and
(iv) save and associate the back-calculated position of the corresponding lift point with the vehicle.

4. The system of claim 3, wherein the one or more processors are further configured to, during a subsequent use with the vehicle and for each lift arm of the set of lift arms:
(i) identify the previously saved, back-calculated position of the corresponding lift point; and
(ii) automatically move that lift arm based on the previously saved, back-calculated position of the corresponding lift point.

5. The system of claim 2, wherein the one or more processors, in a local positioning mode, are further configured to, for each lift arm of the set of lift arms, automatically move that lift arm to the pre-position based on:
(i) the position of the vehicle relative to the one or more lift posts, and
(ii) a back-calculated position of the corresponding lift point, where the back-calculated position is determined based on an identification of the vehicle.

6. The system of claim 2, wherein the one or more processors, in an OEM positioning mode, are further configured to, for each lift arm of the set of lift arms, automatically move that lift arm to the pre-position based on:
(i) the position of the vehicle relative to the one or more lift posts, and
(ii) a position of the corresponding lift point that is selected from a lift point dataset provided by a manufacturer of the vehicle based on an identification of the vehicle.

7. The system of claim 2, wherein the one or more processors, in an automatic positioning mode, are further configured to receive an identity of the vehicle and, for each lift arm of the set of lift arms:
(i) automatically move that lift arm to the pre-position based on the position of the vehicle relative to the one or more lift posts and a position of the corresponding lift point, where the corresponding lift point is determined based on the identity of the vehicle;
(ii) perform an object recognition process on the one or more images to identify a location of the corresponding lift point within the one or more images;
(iii) determine a spatial relationship between the corresponding lift point and the adapter based on the location identified; and
(iv) automatically move that lift arm toward the final position based on the spatial relationship between the corresponding lift point and the adapter.

8. The system of claim 7, wherein the one or more processors are further configured to:
(i) perform the object recognition process on the one or more images to identify a location of the optical locator projected onto the area of the vehicle within the one or more images, and
(ii) after automatically moving that lift arm toward the final position based on the spatial relationship, determine whether the location of the optical locator is aligned with the location of the corresponding lift point.

9. The system of claim 8, wherein the one or more processors are further configured to, where the location of the optical locator is not aligned with the location of the corresponding lift point:
(i) redetermine the spatial relationship based on the location of the optical locator and the location of the corresponding lift point, and
(ii) automatically move that lift arm toward the final position based on the redetermined spatial relationship.

10. The system of claim 7, wherein:
(a) each lift arm of the set of lift arms is associated with a dedicated processor of the one or more processors; and
(b) each dedicated processor is configured to perform the object recognition process for its associated lift arm in parallel with the other dedicated processors.

11. The system of claim 1, wherein each lift arm of the set of lift arms comprises:
(a) an extendable member that is operable to horizontally extend and retract the adapter; and
(b) the camera is coupled to the extendable member and provides a static field of view relative to the adapter during extension and retraction of the adapter.

12. The system of claim 11, wherein:
(a) each lift arm of the set of lift arms defines a longitudinal slot, and
(b) the camera is positioned to slide within the longitudinal slot during extension and retraction of the adapter.

13. The system of claim 12, wherein the adapter of each lift arm comprises:
(a) an unobstructed optical axis from inside the adapter through a top plate of the adapter, and
(b) the locator positioned inside the adapter and operable to project the optical locator along the unobstructed optical axis onto a surface above the adapter.

14. The system of claim 1, wherein the one or more processors are further configured to lower the lift arm and vehicle to disengage the adapter with the corresponding lift point.

15. The system of claim 14, wherein the one or more processors are further configured to:
(a) move the lift arm from the final position to the pre-position, and
(b) upon reaching the pre-position, move the lift arm to an initial position so that the vehicle can exit a lift area without contacting the lift arm.

16. A system for vehicle lift positioning comprising:
(a) a lift post;
(b) a lift arm coupled to the lift post, wherein the lift arm comprises:
(i) an adapter, wherein the lift arm is operable to rotate and extend the adapter using a powered mechanism to engage a lift point of a vehicle, and
(ii) a drive assembly, wherein the drive assembly comprises:
(A) a wheel,
(B) a motor operable to drive the wheel in either direction to selectively move the lift arm along a ground surface, and
(C) a suspension coupling configured to flexibly bias the wheel toward the ground surface during operation; and
(c) one or more processors configured to:
(i) use the wheel to move the lift arm to a position, and
(ii) upon the lift arm reaching the position, raise the lift arm to engage the adapter with the lift point of the vehicle.

17. The system of claim 16, wherein the lift arm comprises an inner arm and an outer arm, and further comprising an inner arm actuator operable to extend or retract the inner arm from the outer arm, wherein the inner arm actuator has a static portion.

18. The system of claim 17, wherein the inner arm actuator is positioned within the inner arm, and the static portion is coupled to the inner arm.

19. The system of claim 17, wherein the inner arm and outer arm define an adapter slot, the adapter is slidably positioned in the adapter slot, and the inner arm actuator is operable to:
(a) extend the adapter to a distal limit of the adapter slot;
(b) after said extending, continue to extend the adapter against the distal limit of the adapter slot, thereby extending the inner arm from the outer arm;
(c) retract the adapter to a proximal limit of the adapter slot; and
(d) after said retracting, continue to retract the adapter against the proximal limit of the adapter slot, thereby retracting the inner arm into the outer arm.

20. A method for vehicle lift positioning, comprising:
(a) using one or more processors, receiving an identification of a vehicle in a lift area;
(b) determining a location of the vehicle within the lift area based on a set of lift area data from a set of lift sensors;
(c) determining positions of a set of lift points for the vehicle based on the identification and the location of the vehicle; and
(d) for at least one lift arm of a set of lift arms:
(i) matching that lift arm with one of the lift points in the set of lift points;
(ii) operating one or more motors to move that lift arm to a pre-position relative to the vehicle based on a position of a corresponding lift point of the set of lift points, wherein the pre-position is offset from the position of the corresponding lift point by a configured arm extension distance;
(iii) capturing one or more images of the vehicle;
(iv) performing a feature recognition process on the one or more images to identify a location of the corresponding lift point within the one or more images, wherein the location of the corresponding lift point is determined directly or as a function of a configured offset from another identified feature of the vehicle within the one or more images;
(iv) displaying an alignment indicator;
(v) overlaying a target box on the corresponding lift point based on the feature recognition process;
(vi) operating the one or more motors to rotate that lift arm until the alignment indicator is aligned with the corresponding lift point;
(vii) identifying in the one or more images an optical locator projected onto the vehicle and overlaying a locator indicator onto the optical locator; and
(viii) operating the one or more motors to extend the lift arm until the locator indicator is within the target box.
